(19) United States
(12) Patent Application Publication
(10) Pub. No.: US 2025/0356801 A1
(43) Pub. Date: Nov. 20, 2025

(54) ELECTRONIC DEVICE AND OPERATING METHOD THEREFOR

(71) Applicant: Samsung Electronics Co., Ltd., Suwon-si (KR)

(72) Inventors: Eunjin LEE, Suwon-si (KR); Seungryeol KIM, Suwon-si (KR); Kyoungmin PARK, Suwon-si (KR); Minwoo LEE, Suwon-si (KR); Kwangtai KIM, Suwon-si (KR); Donghyun YEOM, Suwon-si (KR)

(21) Appl. No.: 19/282,337

(22) Filed: Jul. 28, 2025

Related U.S. Application Data
(63) Continuation of application No. PCT/KR2024/001343, filed on Jan. 29, 2024.

(30) Foreign Application Priority Data
Jan. 31, 2023 (KR) 10-2023-0012291
Mar. 21, 2023 (KR) 10-2023-0036699

(51) Int. Cl. G09G 3/3225; G06T 7/90; G09G 3/32

(52) U.S. Cl. CPC G09G 3/3225; G06T 7/90; G09G 3/32; G09G 2320/0666; G09G 2360/144

(57) ABSTRACT

An electronic device is provided. The electronic device includes a display, a display driver configured to drive the display, multiple sensor circuits configured to sense an illuminance value and an infrared ray (IR) value, multiple camera circuits configured to sense a color temperature, memory comprising one or more storage media, storing instructions, and one or more processors communicatively coupled to the display driver, the multiple sensor circuits, and the multiple camera circuits, and the memory, wherein the instructions, when executed by the one or more processors individually or collectively, cause the electronic device to operate at least one of the multiple sensor circuits to obtain an illuminance value around the electronic device, operate at least one of the multiple sensor circuits to obtain an IR value around the electronic device, determine whether a color temperature around the electronic device is changed, based on the illuminance value and the IR value around the electronic device, in case of determining that the color temperature around the electronic device is changed, drive at least one of the multiple camera circuits to obtain a color temperature value around the electronic device, and control an operation of the display driver to change a color temperature of the display, based on the color temperature value around the electronic device.

### CROSS-REFERENCE TO RELATED APPLICATION(S)

This application is a continuation application, claiming priority under 35 U.S.C. § 365 (c), of an International application No. PCT/KR2024/001343, filed on Jan. 29, 2024, which is based on and claims the benefit of a Korean patent application number 10-2023-0012291, filed on Jan. 31, 2023, in the Korean Intellectual Property Office, and of a Korean patent application number 10-2023-0036699, filed on Mar. 21, 2023, in the Korean Intellectual Property Office, the disclosure of each of which is incorporated by reference herein in its entirety.

### BACKGROUND

### 1. Field

The disclosure relates to an electronic device which may change a color temperature of a display according to a color temperature of an area around the electronic device (e.g., a smartphone, a personal computer (PC), a wearable electronic device, and a smart watch) and an operating method therefor.

### 2. Description of Related Art

Electronic devices may refer to devices performing a particular function according to an equipped program thereof, such as a home appliance, an electronic scheduler, a portable multimedia player, a mobile communication terminal, a tablet PC, a video/sound device, a desktop/laptop computer, or a navigation system for automobile. For example, such electronic devices may output stored information in the form of sound or image. As electronic devices become more integrated and high-speed and high-capacity wireless communications become more commonplace, a variety of functions are now being integrated into a single mobile phone. As the functionality of electronic devices diversifies, an electronic device may have multiple sensors deployed to implement different functions. For example, it is possible to improve the visibility of a user by measuring the ambient brightness through an illuminance sensor disposed on the front surface of an electronic device and using the measured value to adjust the brightness and color of a display.

The above information is presented as background information only to assist with an understanding of the disclosure. No determination has been made, and no assertion is made, as to whether any of the above might be applicable as prior art with regard to the disclosure.

### SUMMARY

The surroundings (e.g., a color temperature) of an electronic device (e.g., a smartphone, a tablet personal computer (PC), a wearable electronic device, and a smart watch) may reduce the visibility of a display and cause user fatigue. In case that an electronic device includes an illuminance sensor without a function to sense a color (e.g., R, G, and B) of light, it may be impossible to sense a color temperature around the electronic device only using the illuminance sensor.

Aspects of the disclosure are to address at least the above-mentioned problems and/or disadvantages and to provide at least the advantages described below. Accordingly, an aspect of the disclosure is to provide an electronic device which may sense (e.g., measure) a color temperature around the electronic device by using an illuminance sensor, an infrared ray (IR) sensor, and a camera module and change (e.g., adjust or control) a color temperature of a display to match the color temperature around the electronic device, and an operating method therefor.

Another aspect of the disclosure is to provide an electronic device which may sense (e.g., measure) a color temperature around the electronic device by using a camera module disposed in the electronic device and change (e.g., adjust or control) a color temperature of a display based on the color temperature around the electronic device so as to reduce power consumption due to the driving of the camera module, and an operating method therefor.

Additional aspects will be set forth in part in the description which follows and, in part, will be apparent from the description, or may be learned by practice of the presented embodiments.

In accordance with an aspect of the disclosure, an electronic device is provided. The electronic device includes a display, a display driver configured to drive the display, multiple sensor circuits configured to sense an illuminance value and an infrared ray (IR) value, multiple camera circuits configured to sense a color temperature; memory comprising one or more storage media, storing instructions, and one or more processors communicatively coupled to the display driver, the multiple sensor circuits, the multiple camera circuits, and the memory, wherein the instructions, when executed by the one or more processors individually or collectively, cause the electronic device to operate at least one of the multiple sensor circuits to obtain an illuminance value around the electronic device, operate at least one of the multiple sensor circuits to obtain an IR value around the electronic device, determine whether a color temperature around the electronic device is changed, based on the illuminance value and the IR value around the electronic device, in case of determining that the color temperature around the electronic device is changed, drive at least one of the multiple camera circuits to obtain a color temperature value around the electronic device, and control an operation of the display driver to change a color temperature of the display, based on the color temperature value around the electronic device.

In accordance with another aspect of the disclosure, a method performed by an electronic device is provided. The method includes operating, by the electronic device, at least one of multiple sensor circuits to obtain an illuminance value around the electronic device, operating, by the electronic device, at least one of the multiple sensor circuits to obtain an infrared ray (IR) value around the electronic device, determining, by the electronic device, whether a color temperature around the electronic device is changed, based on the illuminance value and the IR value around the electronic device, in case of determining that the color temperature around the electronic device is changed, driving, by the electronic device, at least one of multiple camera circuits to obtain a color temperature value around the electronic device, and changing, by the electronic device, a color temperature of a display, based on the color temperature value around the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include operating, by the electronic device, at least one of multiple sensor circuits to obtain an illuminance value around the electronic device, operating, by the electronic device, at least one of the multiple sensor circuits to obtain an infrared ray (IR) value around the electronic device, determining, by the electronic device, whether a color temperature around the electronic device is changed, based on the illuminance value and the IR value around the electronic device, in case of determining that the color temperature around the electronic device is changed, driving, by the electronic device, at least one of multiple camera circuits to obtain a color temperature value around the electronic device, and changing, by the electronic device, a color temperature of a display, based on the color temperature value around the electronic device.

The electronic device and the operating method therefor according to an embodiment of the disclosure may use a camera module to sense a color temperature around the electronic device and change (e.g., adjust or control) a color temperature of a display to match the color temperature around the electronic device, thereby providing a user with a comfortable and color-accurate screen.

According to an embodiment of the disclosure, the electronic device and the operating method therefor may sense (e.g., measure) a color temperature around the electronic device by using a camera module disposed in the electronic device and change (e.g., adjust or control) a color temperature of a display, based on the color temperature around the electronic device so as to reduce power consumption due to the driving of the camera module.

According to an embodiment of the disclosure, the electronic device and the operating method therefor increase a sampling rate of a sensor module and shorten a sampling interval in a low illuminance environment having an illuminance value equal to or less than a preconfigured illuminate value. As such, it is possible to improve the sensing performance of ambient illuminance values and IR values of the electronic device.

According to an embodiment of the disclosure, the electronic device and the operating method therefor reduce a sampling rate of a sensor module and increase a sampling interval in a high illuminance environment in which an illuminance value around the electronic device is equal to or greater than a preconfigured illuminate value. As such, unnecessary power consumption of electronic devices is reduced.

According to an embodiment of the disclosure, the electronic device and the operating method therefor increase a sampling rate of a camera module and shorten a sampling interval in a low illuminance environment in which an illuminance value around the electronic device is equal to or less than a preconfigured illuminate value. As such, it is possible to improve the sensing performance of ambient color temperature values of the electronic device.

According to an embodiment of the disclosure, the electronic device and the operating method therefor reduce a sampling rate of a camera module and increase a sampling interval in a high illuminance environment in which an illuminance value around the electronic device is equal to or greater than a preconfigured illuminate value. As such, unnecessary power consumption of electronic devices is reduced.

According to an embodiment of the disclosure, the electronic device and the operating method therefor prevent the color temperature around the electronic device from being incorrectly perceived as being changed even though the color temperature around has not been actually changed, and prevent frequent color temperature changes (e.g., adjustments or controls) of the display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B are views illustrating an electronic device in an unfolded state viewed from a front surface and a rear surface according to various embodiments of the disclosure;

FIGS. 2C and 2D are views illustrating an electronic device in a folded state viewed from a front surface and a rear surface according to various embodiments of the disclosure;

FIG. 3A is a perspective view illustrating a first surface (e.g., a front surface) of an electronic device according to an embodiment of the disclosure;

FIG. 3B is a perspective view illustrating a second surface (e.g., a rear surface) of an electronic device according to an embodiment of the disclosure;

FIG. 4A is a block view illustrating a display module according to an embodiment of the disclosure;

FIG. 4B is a block view illustrating a display module according to an embodiment of the disclosure;

FIG. 5 is a flowchart illustrating an operating method of an electronic device according to an embodiment of the disclosure;

FIG. 6 is a view illustrating a spectral power distribution (SPD) for each color temperature of a light (or light source) according to an embodiment of the disclosure;

FIG. 7 is a view illustrating an infrared ray (IR) sensing value according to an illuminance and a color temperature around an electronic device according to an embodiment of the disclosure;

FIGS. 8A, 8B, 8C, 8D, 8E, and 8F are views illustrating a spectral power distribution (SPD) according to a type of light (or light source) according to various embodiments of the disclosure;

FIG. 9 is a view illustrating data of a sensor module (e.g., an illuminance sensor) according to a type of light (or light source) according to an embodiment of the disclosure;

FIG. 10 is a view illustrating a color temperature band for each type of light (or light source) according to an embodiment of the disclosure;

FIG. 11 is a view illustrating determining of turning on or off of cameras according to a posture (or angle) of an electronic device according to an embodiment of the disclosure;

FIG. 12 is a view illustrating a method for sampling of a sensor value and a color temperature value according to an embodiment of the disclosure; and

FIG. 13 is a flowchart illustrating an operating method of an electronic device according to an embodiment of the disclosure.

Throughout the drawings, it should be noted that like reference numerals are used to depict the same or similar elements, features, and structures.

### DETAILED DESCRIPTION

The following description with reference to the accompanying drawings is provided to assist in comprehensive understanding of various embodiments of the disclosure as defined by the claims and their equivalents. It includes various specific details to assist in the understanding but these are to be regarded as merely exemplary. Accordingly, those or ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

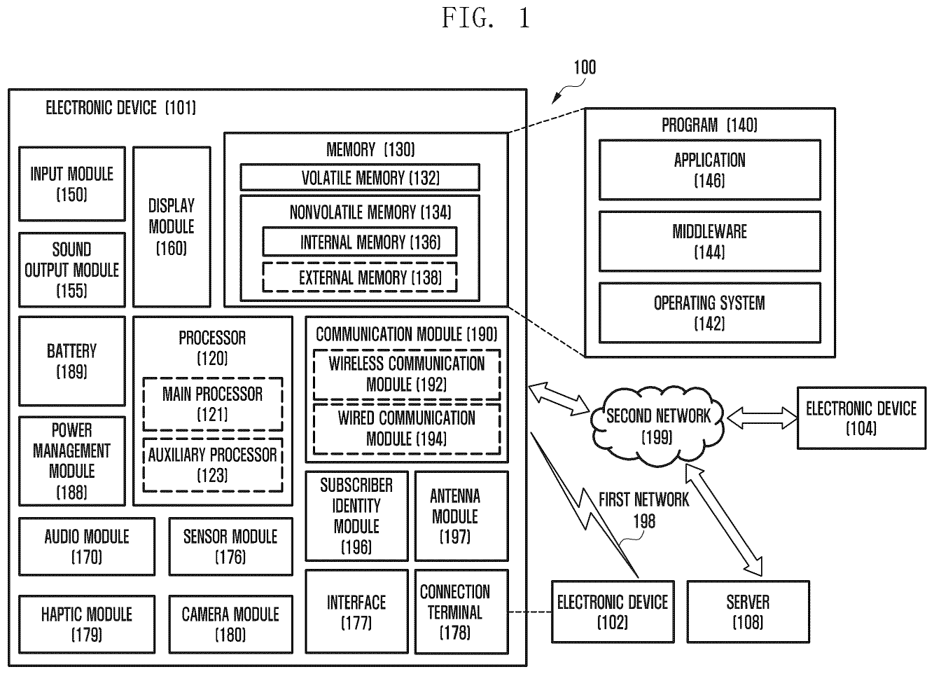

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, the display module 160 may include a flexible display configured to be folded or unfolded.

According to an embodiment, the display module 160 may include a flexible display providing a slidably arranged screen (for example, a display screen).

According to an embodiment, the display module 160 may be also referred to as a variable display (e.g., a stretchable display), an expandable display, or a slide-out display.

According to an embodiment, the display module 160 may include a bar type or plate type display.

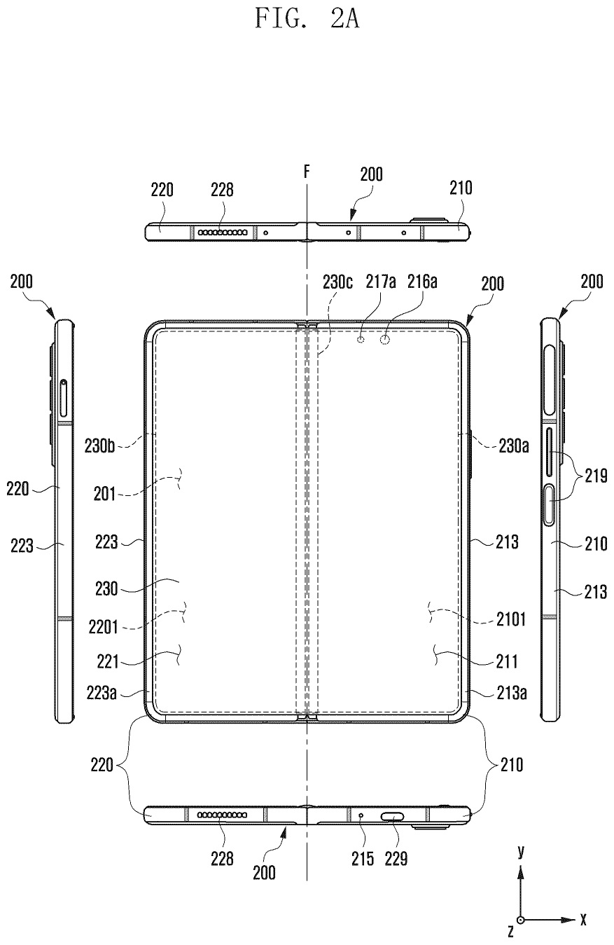

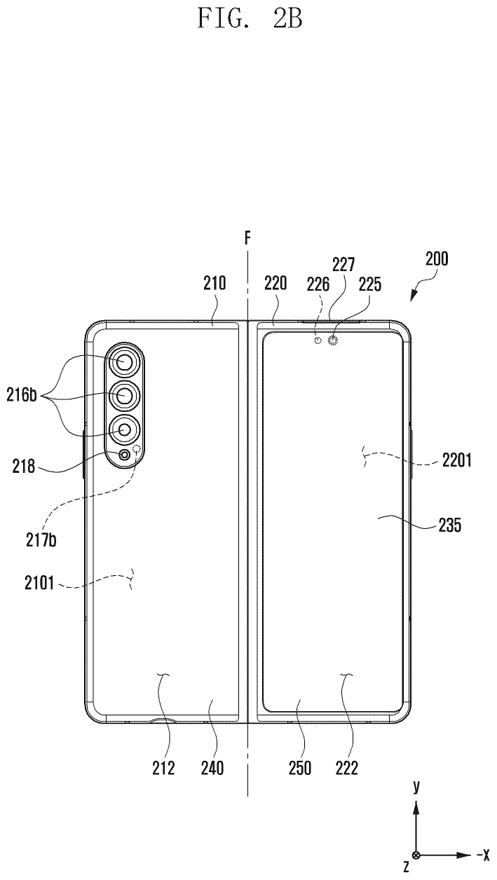

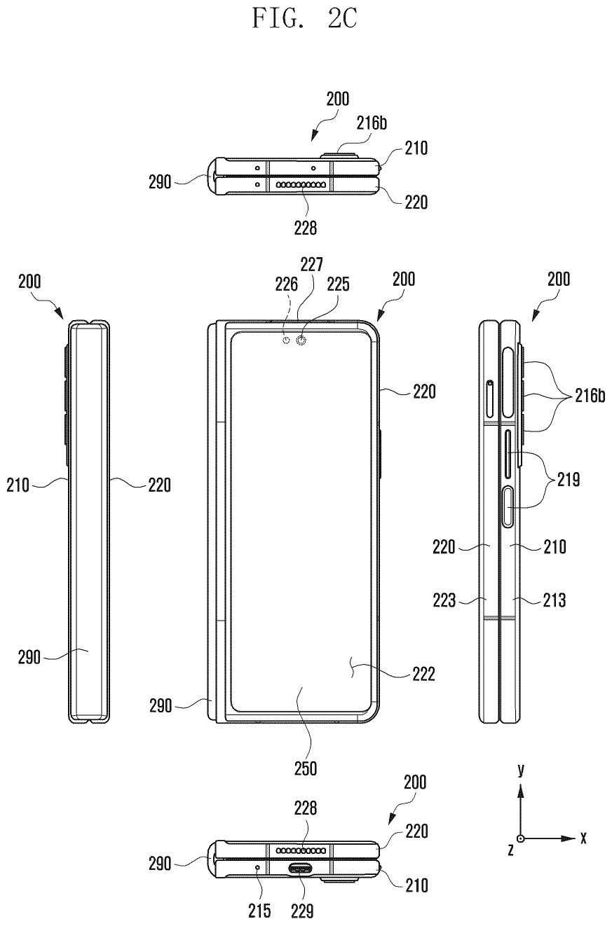

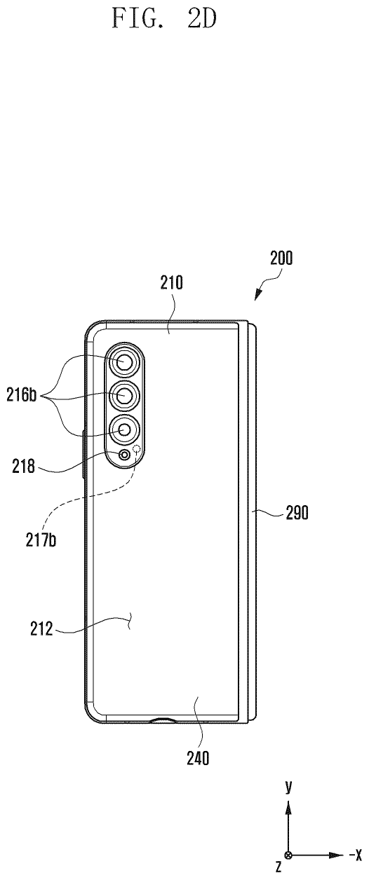

FIGS. 2A and 2B are views illustrating an electronic device in an unfolded state viewed from a front surface and a rear surface according to various embodiments of the disclosure. FIGS. 2C and 2D are views illustrating an electronic device in a folded state viewed from a front surface and a rear surface according to various embodiments of the disclosure.

Referring to FIGS. 2A, 2B, 2C and 2D, the electronic device 200 (e.g., the electronic device 101 in FIG. 1) according to an embodiment of the disclosure may include a pair of housings 210 and 220 (e.g., a foldable housing structure) rotatably coupled to each other around a folding axis F through at least one hinge device (e.g., the hinge module or hinge structure) to be foldable with respect to each other, a first display 230 (e.g., a flexible display, a foldable display, or a main display) disposed through the pair of housings 210 and 220, and/or a second display 235 (e.g., a sub-display) disposed through a second housing 220.

According to an embodiment, at least a portion of the at least one hinge device may be disposed not to be seen from the outside through a first housing 210 and the second housing 220 and disposed not to be seen through a hinge housing 290 (e.g., a hinge cover) configured to cover a foldable portion in the unfolded state. In the disclosure, a surface on which the first display 230 is disposed may be defined as a front surface of the electronic device 200. In the disclosure, a surface opposite to the front surface may be defined as a rear surface of the electronic device 200. A surface surrounds a space between the front surface and the rear surface may be defined as a lateral surface of the electronic device 200.

According to an embodiment, the pair of housings 210 and 220 may include the first housing 210 and the second housing 220 arranged to be foldable with respect to each other through the at least one hinge device.

According to an embodiment, the pair of housings 210 and 220 are not limited to the shape and combination described in FIGS. 2A to 2D, and may be implemented by another shape or a combination and/or coupling of components.

According to an embodiment, the first housing 210 and the second housing 220 may be arranged on opposite sides around the folding axis F, folded an overall symmetric shape with respect to the folding axis F, and folded to match each other.

According to an embodiment, the first housing 210 and the second housing 220 may be folded to be asymmetric based on the folding axis F.

According to an embodiment, an angle and a distance between the first housing 210 and the second housing 220 may vary according to whether the electronic device 200 is in the unfolded state, the folded state, or an intermediate state. For example, the electronic device 200 may sense whether it is in the unfolded state, the folded state, or the intermediate state, by using a sensor module (e.g., the sensor module 176 in FIG. 1). The electronic device 200 may sense the angle between the first housing 210 and the second housing 220 by using the sensor module (e.g., the sensor module 176 in FIG. 1).

According to an embodiment, the first housing 210 may be connected to the at least one hinge device in the unfolded state of the electronic device 200. The first housing 210 may include a first surface 211 disposed to face the front surface of the electronic device 200, a second surface 212 facing a direction opposite to the first surface 211, and/or a first lateral member 213 surrounding at least a portion of a first space 2101 between the first surface 211 and the second surface 212.

According to an embodiment, the second housing 220 may be connected to the at least one hinge device in the unfolded state of the electronic device 200. The second housing 220 may include a third surface 221 disposed to face the front surface of the electronic device 200, a fourth surface 222 facing a direction opposite to the third surface 221, and/or a second lateral member 223 surrounding at least a portion of a second space 2201 between the third surface 221 and the fourth surface 222.

According to an embodiment, the first surface 211 may face a direction substantially identical to the third surface 221 in the unfolded state, and may be at least partially face the third surface 221 in the folded state.

According to an embodiment, the electronic device 200 may include a recess 201 configured to receive the first display 230 through a structural coupling of the first housing 210 and the second housing 220.

According to an embodiment, the recess 201 may have a size substantially identical to that of the first display 230.

According to an embodiment, the first housing 210 may be coupled to the first lateral member 213 when viewing the first display 230 from above. The first housing 210 may include a first protection frame 213a (e.g., a first decoration member) disposed to overlap an edge of the first display 230 so as to cover the edge of the first display 230 not to be seen from the outside.

According to an embodiment, the first protection frame 213a may be integrally formed with the first lateral member 213.

According to an embodiment, the second housing 220 may be coupled to the second lateral member 223 when viewing the first display 230 from above. The second housing 220 may include a second protection frame 223a disposed to overlap an edge of the first display 230 so as to cover the edge of the first display 230 not to be seen from the outside.

According to an embodiment, the second protection frame 223a may be integrally formed with the second lateral member 223. In an embodiment, the first protection frame 213a and the second protection frame 223a may be omitted.

According to an embodiment, the hinge structure 290 (e.g., the hinge cover) may be disposed between the first housing 210 and the second housing 220. The hinge housing 290 may be disposed to cover a portion (e.g., at least one hinge module) of the at least one hinge device.

According to an embodiment, the hinge housing 290 may be covered or exposed to the outside by a portion of the first housing 210 and the second housing 220 depending on the unfolded state, the folded state, or the intermediate state of the electronic device 200. For example, in case that the electronic device 200 is in the unfolded state, at least a portion of the hinge cover 290 may be disposed to be covered by the first housing 210 and the second housing 220 and not to be substantially seen from the outside.

According to an embodiment, at least a portion of the hinge housing 290, in case that the electronic device 200 is in the folded state, may be disposed between the first housing 210 and the second housing 220 to be seen from the outside.

According to an embodiment, in the intermediate state in which the first housing 210 and the second housing 220 are folded with a certain angle, the hinge housing 290 may be disposed to be at least partially seen from the outside of the electronic device 200 between the first housing 210 and the second housing 220. For example, an area through which the hinge housing 290 is exposed to the outside may be smaller than that in a completed folded state. According to an embodiment, the hinge housing 290 may include a curved surface.

According to an embodiment, in case that the electronic device 200 is in the unfolded state (e.g., the state in FIGS. 2A and 2B), the first housing 210 and the second housing 220 may have an angle of 180° therebetween, and a first area 230a, a second area 230b, and a folding area 230c of the first display 230 may be arranged to define the same plane. The first area 230a, the second area 230b, and the folding area 230c of the first display 230 may be arranged to face a substantially identical direction (e.g., the z-axis direction). In an embodiment, in case that the electronic device 200 is in the unfolded state, the first housing 210 may rotate at an angle of about 360° with respect to the second housing 220 to be reversely folded (e.g., an out-folding method) so that the second surface 212 and the fourth surface 222 face each other.

According to an embodiment, in case that the electronic device 200 is in the folded state (e.g., the state in FIGS. 2C and 2D), the first surface 211 of the first housing 210 and the third surface 221 of the second housing 220 may be arranged to face each other. In this case, the first area 230a and the second area 230b of the first display 230 may be arranged to face each other while configuring a narrow angle (e.g., a range of 0 degrees to about 10 degrees) therebetween through the folding area 230c. According to an embodiment, at least a portion of the folding area 230c may be changed to be a curved shape having a certain curvature.

According to an embodiment, in case that the electronic device 200 is in the intermediate state, the first housing 210 and the second housing 220 may be arranged to have a certain angle therebetween. In this case, the first area 230a and the second area 230b of the first display 230 may configure an angle larger than that of the folded state and smaller than that of the unfolded state, and the curvature of the folding area 230c may be smaller than that of the folded state and larger than that of the unfolded state. In an embodiment, the first housing 210 and the second housing 220 may configure an angle that may stop at a specified folding angle between the folded state and the unfolded state through the at least one hinge device (e.g., a free stop function). In an embodiment, the first housing 210 and the second housing 220 may be continuously operated while being pressurized in an unfolding direction or a folding direction based on a designated inflection angle, through the at least one hinge device.

According to an embodiment, the electronic device 200 may include at least one of at least one display 230 or 235 disposed in the first housing 210 and/or the second housing 220, an input device 215, audio output devices 227 and 228, a sensor module 217a, 217b, or 226, camera modules 216a, 216b, and 225, a key input device 219, an indicator (not shown), or a connector port 229. In an embodiment, the electronic device 200 may omit at least one of the components or may additionally include at least one other component.

According to an embodiment, the at least one display 230 or 235 may include the first display 230 (e.g., a flexible display) disposed from the first surface 211 of the first housing 210 to be supported by the third surface 221 of the second housing 220 through the at least one hinge device and the second display 235 disposed in an internal space of the second housing 220 to be at least partially seen from the outside through the fourth surface 222.

In an embodiment, the second display 235 may be disposed in an internal space of the first housing 210 to be seen from the outside through the second surface 212.

According to an embodiment, the first display 230 may be mainly used in the unfolded state of the electronic device 200. The second display 235 may be also used in the unfolded state of the electronic device 200.

According to an embodiment, the second display 235 may be mainly used in the folded state of the electronic device 200. The first display 230 may be also used in the folded state of the electronic device 200.

According to an embodiment, in the intermediate state, the electronic device 200 may control the first display 230 and/or the second display 235 to be usable based on a folding angle of the first housing 210 and the second housing 220.

According to an embodiment, the first display 230 may be disposed in a reception space defined by the pair of housings 210 and 220. For example, the first display 230 may be disposed in the recess 201 defined by the pair of housings 210 and 220, and may be disposed to occupy substantially most of the front surface of the electronic device 200 in the unfolded state. According to an embodiment, the first display 230 may include a flexible display having at least a partial area transformable to a flat surface or a curved surface.

According to an embodiment, the first display 230 may include the first area 230a facing the first housing 210 and the second area 230b facing the second housing 220. According to an embodiment, the first display 230 may include the folding area 230c including a portion of the first area 230a and a portion of the second area 230b based the folding axis F.

According to an embodiment, at least a portion of the folding area 230c may include an area corresponding to the at least one hinge device.

According to an embodiment, the area division of the first display 230 is a physical division by the pair of housings 210 and 220 and the at least one hinge device, and the first display 230 may be displayed as a substantially seamless single full screen through the pair of housings 210 and 220 and the at least one hinge device.

According to an embodiment, the first area 230a and the second area 230b may have an overall symmetrical shape or a partially asymmetrical shape based on the folding area 230c.

According to an embodiment, the electronic device 200 may include a first rear cover 240 disposed on the second surface 212 of the first housing 210 and a second rear cover 250 disposed on the fourth surface 222 of the second housing 220. In an embodiment, at least a portion of the first rear cover 240 may be integrally formed with the first lateral member 213. In an embodiment, at least a portion of the second rear cover 250 may be integrally formed with the second lateral member 223.

According to an embodiment, at least one of the first rear cover 240 and the second rear cover 250 may be made of a substantially transparent plate (e.g., a polymer plate or a glass plate including various coating layers) or an opaque plate. According to an embodiment, the first rear cover 240 may be made of an opaque plate such as coated or tinted glass, ceramic, polymer, a metal (e.g., aluminum, stainless steel (STS), or magnesium), or a combination of at least two of the materials.

According to an embodiment, the second rear cover 250 may be configured through a substantially transparent plate such as glass or polymer. Accordingly, the second display 235 may be disposed in an internal space of the second housing 220 to be seen from the outside through the second rear cover 250.

According to an embodiment, the input device 215 may include a microphone. According to an embodiment, the input device 215 may include multiple microphones arranged so as to detect a direction of a sound.

According to various embodiments, the audio output devices 227 and 228 may include speakers. According to an embodiment, the audio output devices 227 and 228 may include a call receiver 227 disposed through the fourth surface 222 of the second housing 220 and an external speaker 228 disposed through at least a portion of the second lateral member 223 of the second housing 220.

According to an embodiment, the input device 215, the audio output devices 227 and 228, and the connector port 229 may be disposed in spaces of the first housing 210 and/or the second housing 220. The input device 215, the audio output devices 227 and 228, and the connector port 229 may be exposed to an external environment through at least one hole disposed through the first housing 210 and/or the second housing 220. In an embodiment, holes disposed through the first housing 210 and/or the second housing 220 may be commonly used for the input device 215 and the audio output devices 227 and 228. In an embodiment, the audio output devices 227 and 228 may include a speaker (e.g., a piezo speaker) operating without a hole disposed through the first housing 210 and/or the second housing 220.

According to an embodiment, the camera modules 216a, 216b, and 225 may include a first camera module 216a disposed on the first surface 211 of the first housing 210, a second camera module 216b disposed on the second surface 212 of the first housing 210, and/or a third camera module 225 disposed on the fourth surface 222 of the second housing 220.

According to an embodiment, the electronic device 200 may include a flash 218 disposed adjacent to the second camera module 216b. According to an embodiment, the flash 218 may include, for example, a light-emitting diode or a xenon lamp.

According to an embodiment, the camera modules 216a, 216b, and 225 may include one or more of lenses, an image sensor, and/or an image signal processor. According to an embodiment, at least one of the camera modules 216a, 216b, and 225 may include two or more lenses (e.g., a wide-angle and telephoto lens) and image sensors and may be disposed together on one surface of the first housing 210 and/or the second housing 220.

According to an embodiment, the sensor modules 217a, 217b and 226 (e.g., the sensor module 176 in FIG. 1) may generate an electrical signal or data corresponding to an internal operation state or an external environment state of the electronic device 200.

According to an embodiment, the sensor modules 217a, 217b and 226 (e.g., the sensor module 176 in FIG. 1) may include a first sensor module 217a disposed on the first surface 211 of the first housing 210, a second sensor module 217b disposed on the second surface 212 of the first housing 210, and/or a third sensor module 226 disposed on the fourth surface 222 of the second housing 220.

In an embodiment, the sensor modules 217a, 217b and 226 (e.g., the sensor module 176 in FIG. 1) may include at least one of a gesture sensor, a grip sensor, a color sensor, an infrared (IR) sensor, an illumination sensor, an ultrasonic sensor, an iris recognition sensor, or a distance detection sensor (e.g., a time of flight (TOF) sensor or a light detection and ranging (LiDAR) sensor).

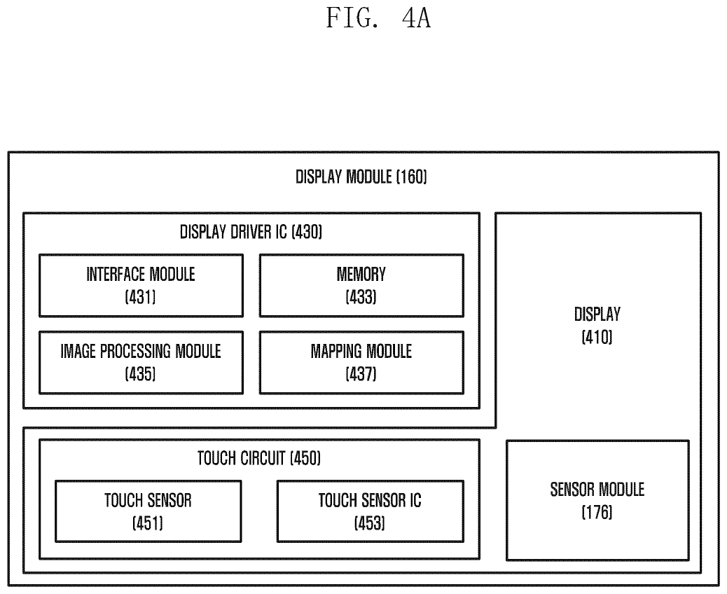

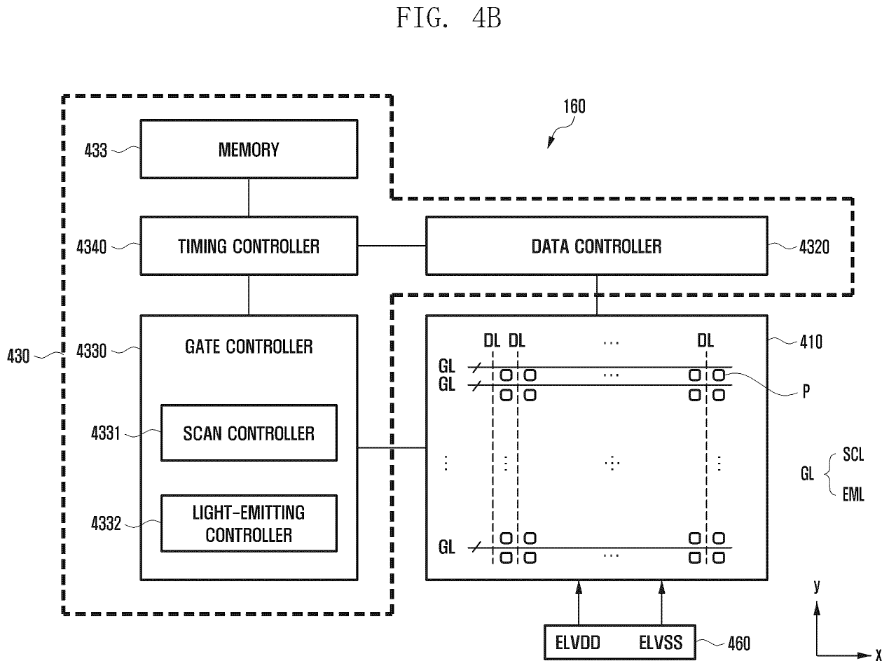

According to an embodiment, a processor (e.g., the processor 120 in FIG. 1) of the electronic device 200 may operate the sensor modules 217a, 217b and 226 (e.g., the sensor module 176 in FIG. 1) and sense an illuminance and/or an IR strength around the electronic device 200. The processor 120 may obtain information about the illuminance and information about the IR strength around the electronic device 200. For example, the processor 120, based on the information about the illuminance and the information about the IR strength around the electronic device 200, may control an operation of a display driver IC (e.g., a display driving driver) (e.g., a DDIC 430 in FIGS. 4A and 4B) to change (e.g., adjust or control) a color temperature of the display 230 or 235. The DDIC 430 may change (e.g., adjust or control) the color temperature of the display 230 or 235 based on the control of the processor 120.

According to an embodiment, the processor (e.g., the processor 120 in FIG. 1) of the electronic device 200 may operate one or more cameras (e.g., an image sensor) and sense the color temperature around the electronic device 200. The processor 120 may obtain a color temperature value around the electronic device 200. For example, the processor 120, based on the color temperature value around the electronic device 200, may control an operation of the display driver IC (e.g., a display driving driver) (e.g., the DDIC 430 in FIGS. 4A and 4B) to change (e.g., adjust or control) the color temperature of the display 230 or 235. The DDIC 430 may change (e.g., adjust or control) the color temperature of the display 230 or 235 based on the control of the processor 120.

According to an embodiment, a processor (e.g., the processor 120 in FIG. 1) of the electronic device 200 may operate the sensor modules 217a, 217b and 226 (e.g., the sensor module 176 in FIG. 1) and sense a type of light (or light source) around the electronic device 200. The processor 120 may obtain information about the type of the light (or light source) around the electronic device 200. For example, the processor 120, based on the information about the type of the light (or light source) around the electronic device 200, may control an operation of the display driver IC (e.g., a display driving driver) (e.g., the DDIC 430 in FIGS. 4A and 4B) to change (e.g., adjust or control) the color temperature of the display 230 or 235. The DDIC 430 may change (e.g., adjust or control) the color temperature of the display 230 or 235 based on the control of the processor 120.

According to an embodiment, the electronic device 200 may further include at least one of a barometric sensor, a magnetic sensor (e.g., a 6-axis sensor or a geomagnetic sensor), an acceleration sensor, a biometric sensor, a temperature sensor, a humidity sensor, or a fingerprint recognition sensor, not shown. In an embodiment, the fingerprint recognition sensor may be disposed through at least one of the first lateral member 213 of the first housing 210 and/or the second lateral member 223 of the second housing 220.

According to an embodiment, the key input device 219 may be disposed to be exposed to the outside through the first lateral member 213 of the first housing 210. In an embodiment, the key input device 219 may be disposed to be exposed to the outside through the second lateral member 223 of the second housing 220. In an embodiment, the electronic device 200 may not include a portion or entirety of the key input device 219, and the excluded key input device 219 may be implemented as various forms, such as a soft key, on the at least one display 230 or 235. As an embodiment, the key input device 219 may be implemented using a pressure sensor included in the at least one display 230 or 235.

According to an embodiment, the connector port 229 may include a connector (e.g., a USB connector or an interface connector port (IF) module) configured to transmit or receive power and/or data to or from an external electronic device. In an embodiment, the connector port 229 may concurrently perform functions to transmit or receive an audio signal to or from an external electronic device or may further include a separate connector port (e.g., an ear jack hole) to perform function to transmit or receive an audio signal.

According to an embodiment, at least one camera module 216a or 225 among the camera modules 216a, 216b, and 225, at least one sensor module 217a or 226 among the sensor modules 217a, 217b, and 226, and/or the indicator may be arranged to be visually exposed through the at least one display 230 or 235. For example, at least one camera module 216a or 225, at least one sensor module 217a or 226, and/or the indicator may be arranged under an activation area (display area) of the at least one display 230 or 235 within an internal space of at least one housing 210 or 220. At least one camera module 216a or 225, at least one sensor module 217a or 226, and/or the indicator may be arranged to be in contact with the external environment through a transparent area or an opening perforated through a cover member (e.g., a window layer (not shown) of the first display 230 and/or the second rear cover 250).

According to an embodiment, an area in which the at least one display 230 or 235 and the at least one camera module 216a or 225 face each other may correspond to a portion of an area configured to display contents, and may be configured as a transmission area having predetermined transmittance.

According to an embodiment, the transmission area may be configured to have transmittance in the range of about 5% to about 20%. The transmission area may include an area overlapping an effective area (e.g., a view-angle area) of the at least one camera module 216a or 225 through which light for imaging to an image sensor to generate an image passes. For example, the transmission area of the display 230 or 235 may include an area having a lower pixel density than a peripheral area. For example, the transmission area may be substituted with the opening. For example, the at least one camera module 216a or 225 may include an under-display camera (UDC) or an under-panel camera (UPC). As an embodiment, some of camera modules or sensor modules 217a and 226 may be disposed to perform functions thereof without being visually exposed through the display. For example, an area facing the camera module 216a or 225 and/or the sensor module 217a or 226 disposed under the at least one display 230 or 235 (e.g., a display panel) may have a under-display camera structure and may not need a perforated opening.

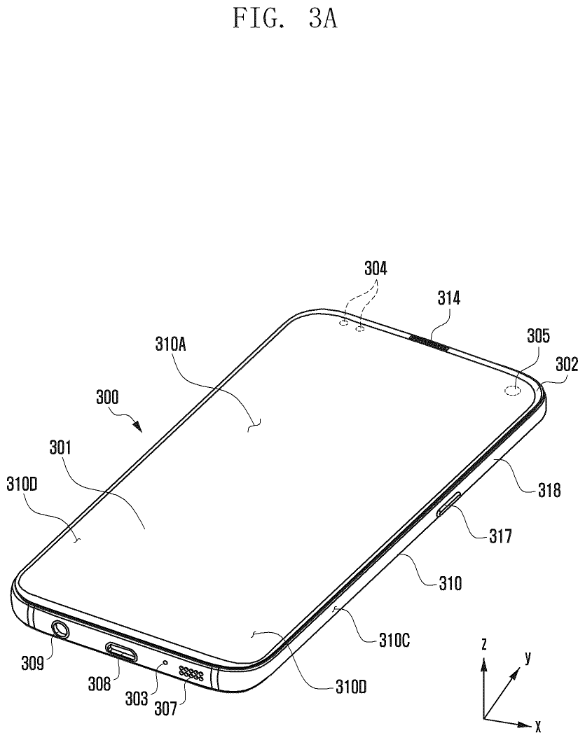

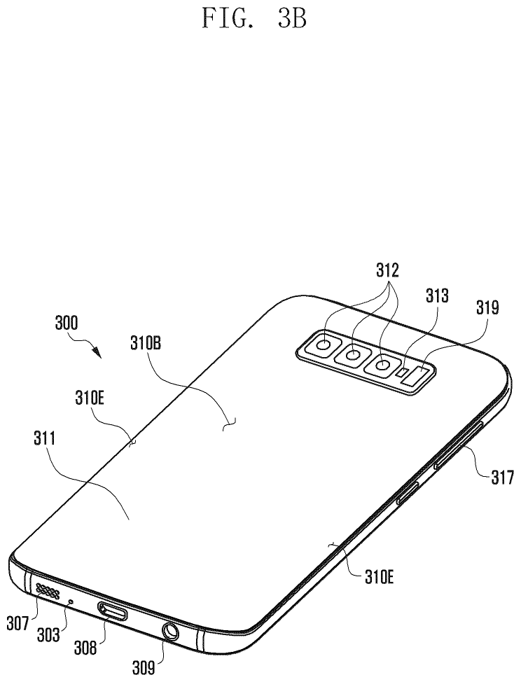

FIG. 3A is a perspective view illustrating a first surface (e.g., a front surface) of an electronic device according to an embodiment of the disclosure. FIG. 3B is a perspective view illustrating a second surface (e.g., a rear surface) of an electronic device according to an embodiment of the disclosure.

Referring to FIGS. 3A and 3B, the electronic device 300 (e.g., the electronic device 101 in FIG. 1) according to an embodiment of the disclosure may include a first surface (or front surface) 310A, a second surface (or rear surface) 310B, and a housing 310. According to an embodiment, the electronic device 300 (e.g., the electronic device 101 in FIG. 1) may include a display 301.

According to an embodiment, the display 301 may be supported by the housing 310. For example, the display 301 may include a liquid crystal display (LCD) display, an organic light emitting diode (OLED) display, or a micro-LED display.

According to an embodiment, the housing 310 may include a lateral surface 310C configured to surround a space between the first surface 310A and the second surface 310B. According to an embodiment, the housing 310 may refer to a structure for configuring a portion of the first surface 310A, the second surface 310B, and the lateral surface 310C.

According to an embodiment, at least a portion of the first surface 310A may include a substantially transparent front plate 302 (e.g., a glass plate including various coating layers, or a polymer plate).

According to an embodiment, the second surface 310B may be made of the substantially opaque rear plate 311. The rear plate 311 may include, for example, coated or colored glass, ceramic, polymers, metals (e.g., aluminum, stainless steel (STS), or magnesium), or a combination of at least two thereof. However, without limitation thereto, the rear plate 311 may be made of transparent glass.

According to an embodiment, the lateral surface 310C may be coupled to the front plate 302 and the rear plate 311 and defined by a lateral bezel structure 318 (or “lateral member”) including a metal and/or polymer. According to an embodiment, the rear plate 311 and the lateral bezel structure 318 may be integrally configured and include an identical material (e.g., a metal material such as aluminum).

According to an embodiment, the front plate 302 may include two first areas 310D seamlessly extending from the first surface 310A to be bent toward the rear plate 311. The two first areas 310D may be disposed at both ends of a long edge of the front plate 302.

According to an embodiment, the rear plate 311 may include two second areas 310E seamlessly extending from the second surface 310B to be bent toward the front plate 302.

According to an embodiment, the front plate 302 (or the rear plate 311) may include only one of the first areas 310D (or the second areas 310E). According to an embodiment, a portion of the first areas 310D or the second areas 310E may be not included.

In some embodiments, when viewed from a lateral side of the electronic device 300, the lateral bezel structure 318 may have a first thickness (or width) at a lateral surface in which the first areas 310D and the second areas 310E are not included. In some embodiments, when viewed from a lateral side of the electronic device 300, the lateral bezel structure 318 may have a second thickness (or width) thinner than the first thickness at a lateral surface in which the first areas 310D and the second areas 310E are included.

According to an embodiment, the electronic device 300 may include at least one of a display 301, an audio input device 303 (e.g., the input module 150 in FIG. 1 or a microphone), an audio output device 307 or 314 (e.g., the audio output module 155 in FIG. 1 or a speaker) (e.g., an audio module), sensor modules 304 and 319 (e.g., the sensor module 176 in FIG. 1), camera modules 305 and 312 (e.g., the camera module 180 in FIG. 1), a flash 313, a key input device 317, an indicator (not shown), and connectors 308 and 309. According to an embodiment, the electronic device 300 may omit at least one (e.g., the key input device 317) of components or may additionally include another component.

According to an embodiment, the display 301 may be visually exposed through an upper portion of the front plate 302.

According to an embodiment, at least a portion of the display 301 may be seen through the front plate 302 configuring the first surface 310A and the first area 310D of the lateral surface 310C. The display 301 may be combined to or disposed adjacent to a touch sensing circuit, a pressure sensor for measuring a strength (pressure) of a touch, and/or a digitizer for detecting a magnetic field-type electronic pen (e.g., a stylus pen).

According to an embodiment, a rear surface of a screen display area of the display 301 may include at least one of a first sensor module 304, camera modules 305 and 312 (e.g., image sensors), an audio output device 314 (e.g., an audio module), and a fingerprint sensor.

According to an embodiment, the display 301 may be combined to or disposed adjacent to a touch sensing circuit, a pressure sensor for measuring a strength (pressure) of a touch, and/or a digitizer for detecting a magnetic field-type electronic pen (e.g., a stylus pen).

According to an embodiment, at least a portion of the sensor module 304 or 319 and/or at least a portion of the key input device 317 may be disposed on the first areas 310D and/or the second areas 310E.

According to an embodiment, the audio input device 303 may include a microphone. According to an embodiment, the input device 303 may include multiple microphones arranged so as to detect a direction of a sound.

According to an embodiment, the audio output device 307 or 314 may include an audio output device 307 operating as an external speaker and an audio output device 314 operating as a call receiver.

In an embodiment, the audio input device 303 (e.g., a microphone), the audio output device 307 or 314, and the connectors 308 and 309 may be arranged in an internal space of the electronic device 300. The audio input device 303 (e.g., a microphone), the audio output device 307 or 314, and the connectors 308 and 309 may be exposed to the external environment through at least one hole formed through the housing 310. In an embodiment, the hole disposed through the housing 310 may be used in common for the audio input device 303 (e.g., a microphone) and the audio output device 307 or 314. In an embodiment, the audio output device 307 or 314 may include a speaker (e.g., a piezo speaker) operating without a hole formed through the housing 310.

In an embodiment, the sensor modules 304 and 319 (e.g., the sensor module 176 in FIG. 1) may generate an electrical signal or data corresponding to an internal operation state or an external environment state of the electronic device 300. The sensor modules 304 and 319 may include a first sensor module 304 (e.g., a proximity sensor) disposed on the first surface 310A of the housing 310 and/or a second sensor module 319 (e.g., a HRM sensor) and/or a third sensor module (not shown) (e.g., a fingerprint sensor) disposed on the second surface 310B of the housing 310. For example, the fingerprint sensor may be disposed on the first surface 310A (e.g., the display 301) and/or on the second surface 310B of the housing 310.

In an embodiment, the sensor modules 304 and 319 (e.g., the sensor module 176 in FIG. 1) may include at least one of a gesture sensor, a grip sensor, a color sensor, an infrared (IR) sensor, an illumination sensor, an ultrasonic sensor, an iris recognition sensor, or a distance detection sensor (e.g., a time of flight (TOF) sensor or a light detection and ranging (LiDAR) sensor).

According to an embodiment, a processor (e.g., the processor 120 in FIG. 1) of the electronic device 300 may operate the sensor modules 304 and 319 (e.g., the sensor module 176 in FIG. 1) and sense an illuminance and/or an IR strength around the electronic device 300. The processor 120 may obtain information about the illuminance and information about the IR strength around the electronic device 300. For example, the processor 120, based on the information about the illuminance and the information about the IR strength around the electronic device 300, may control an operation of a display driver IC (e.g., a display driving driver) (e.g., a DDIC 430 in FIGS. 4A and 4B) to change (e.g., adjust or control) a color temperature of the display 301. The DDIC 430 may change (e.g., adjust or control) the color temperature of the display 301 based on the control of the processor 120.

According to an embodiment, the processor (e.g., the processor 120 in FIG. 1) of the electronic device 300 may operate one or more camera modules 305 and 312 (e.g., an image sensor) and sense the color temperature around the electronic device 300. The processor 120 may obtain a color temperature value around the electronic device 300. For example, the processor 120, based on the color temperature value around the electronic device 300, may control an operation of the display driver IC (e.g., a display driving driver) (e.g., the DDIC 430 in FIGS. 4A and 4B) to change (e.g., adjust or control) the color temperature of the display 301. The DDIC 430 may change (e.g., adjust or control) the color temperature of the display 301 based on the control of the processor 120.

According to an embodiment, a processor (e.g., the processor 120 in FIG. 1) of the electronic device 300 may operate the sensor modules 304 and 319 (e.g., the sensor module 176 in FIG. 1) and sense a type of light (or light source) around the electronic device 300. The processor 120 may obtain information about the type of the light (or light source) around the electronic device 300. For example, the processor 120, based on the information about the type of the light (or light source) around the electronic device 300, may control an operation of the display driver IC (e.g., a display driving driver) (e.g., the DDIC 430 in FIGS. 4A and 4B) to change (e.g., adjust or control) the color temperature of the display 301. The DDIC 430 may change (e.g., adjust or control) the color temperature of the display 301 based on the control of the processor 120.

According to an embodiment, the electronic device 300 may further include at least one of a barometric sensor, a magnetic sensor (e.g., a 6-axis sensor or a geomagnetic sensor), an acceleration sensor, a biometric sensor, a temperature sensor, a humidity sensor, or a fingerprint recognition sensor, not shown.

According to an embodiment, the camera modules 305 and 312 may include the first camera module 305 disposed on the first surface 310A of the electronic device 300, and the second camera module 312 disposed on the second surface 310B. The flash 313 may be disposed around the camera modules 305 and 312. The camera modules 305 and 312 may include one or more of lenses, an image sensor, and/or an image signal processor. The flash 313 may include, for example, a light-emitting diode or a xenon lamp.

According to an embodiment, the first camera module 305 may correspond to an under-display camera (UDC) and may be disposed on a lower portion of a display panel of the display 301. According to an embodiment, two or more lenses (wide-angle and telephoto lens) and image sensors may be arranged on one surface of the electronic device 300. According to an embodiment, multiple first camera modules 305 may be arranged on the first surface (e.g., a surface on which a screen is displayed) of the electronic device 300 in an under-display camera (UDC) scheme.

According to an embodiment, the key input device 317 may be disposed on the lateral surface 310C of the housing 310. According to an embodiment, the electronic device 300 may not include a portion or entirety of the key input device 317 described above, and the excluded key input device 317 may be implemented as various forms such as a soft key on the display 301. According to an embodiment, the key input device 317 may be implemented by using a pressure sensor included in the display 301.

According to an embodiment, the connectors 308 and 309 may include a first connector hole 308 capable of receiving a connector (e.g., a USB connector) for transmitting or receiving power and/or data to or from an external electronic device, and/or a second connector hole 309 (or an earphone jack) capable of receiving a connector for transmitting or receiving an audio signal to or from an external electronic device. The first connector hole 308 may include a universal serial bus (USB) A type or USB C type port. In case that the first connector hole 308 supports the USB C type, the electronic device 300 (e.g., the electronic device 101 in FIG. 1 or the electronic device 200 in FIG. 2A) may supporting USB power delivery (PD) charging.

According to an embodiment, a first camera module 305 of the camera modules 305 and 312 and/or a first sensor module 304 of the sensor modules 304 and 319 may be disposed to be visually exposed through the display 301.

According to an embodiment, in case that the first camera module 305 is disposed in an under-display camera (UDC) scheme, the first camera module 305 may not be visually exposed to the outside.

According to an embodiment, the first camera module 305 may be disposed to overlap a display area and may display a screen in the display area corresponding to the first camera module 305. The first sensor module 304 may be disposed in the inner space of the electronic device 300 to perform functions thereof without being visually exposed through the front plate 302.

FIG. 4A is a block view illustrates a display module according to an embodiment of the disclosure.

Referring to FIG. 4A, the display module 160 (e.g., the display module 160 in FIG. 1) may include a display 410 and a display driver IC (DDIC) 430 (e.g., a display driving driver) for driving the display 410.

According to an embodiment, the DDIC 430 may include an interface module 431, memory 433 (e.g., buffer memory), an image processing module 435, or a mapping module 437.

According to an embodiment, the DDIC 430 may receive image data or image information including an image control signal corresponding to a command for controlling the image data from another component of the electronic device (e.g., the electronic device 101 in FIG. 1, the electronic device 200 in FIGS. 2A and 2B, or the electronic device 300 in FIGS. 3A and 3B) through the interface module 431.

According to an embodiment, the image information may be received from a processor (e.g., the processor 120 in FIG. 1) (e.g., the main processor 121 in FIG. 1) (e.g., an application processor) or an auxiliary processor (e.g., the auxiliary processor 123 in FIG. 1) (e.g., a graphic processing device) operating independently from a function of the main processor 121.

According to an embodiment, the DDIC 430 may perform communication with a touch circuit 450 or a sensor module 176 through the interface module 431. In addition, the DDIC 430 may store at least a portion of the received image information in the memory 433. By way of example, the DDIC 430 may store at least a portion of the received image information in the memory 433 in a unit of frames.

According to an embodiment, the image processing module 435 may perform a preprocessing or postprocessing (e.g., resolution, brightness, or size adjustment) on at least a portion of the image data based on an attribute of the image data or an attribute of the display 410.

According to an embodiment, the mapping module 437 may generate a voltage value or current value corresponding to the image data having been preprocessed or post-processed through the image processing module 435. According to an embodiment, the generation of the voltage value or current value may be performed at least partially based on attributes (e.g., an arrangement (RGB stripe or pentile structure) of pixels or a size of each pixel) of pixels of the display 410.

According to an embodiment, the DDIC 430 may change (e.g., adjust or control) the color temperature of the display 410 (e.g., the display module 160 in FIG. 1, the display 230 or 235 in FIGS. 2A and 2B, or the display 301 in FIG. 3A), based on control of the processor 120.

For example, the DDIC 430 may change (e.g., adjust or control) the color temperature of the display 410 (e.g., the display module 160 in FIG. 1, the display 230 or 235 in FIGS. 2A and 2B, or the display 301 in FIG. 3A), based on the illuminance and/or the IR strength around the electronic device 101, 200, or 300.

For example, the DDIC 430 may control an operation of the display driver IC (e.g., a display driving driver) (e.g., the DDIC 430 in FIG. 4B) to change (e.g., adjust or control) the color temperature of the display 230, 235, or 301, based on the color temperature value around the electronic device 101, 200, 300. The DDIC 430 may change (e.g., adjust or control) the color temperature of the display 230, 235, or 301 based on the control of the processor 120.

For example, the DDIC 430 may change (e.g., adjust or control) the color temperature of the display 410 (e.g., the display module 160 in FIG. 1, the display 230 or 235 in FIGS. 2A and 2B, or the display 301 in FIG. 3A), based on the type of the light (or light source) around the electronic device 200.

According to an embodiment, at least a portion of pixels of the display 410 may be driven based on, for example, at least a portion of the voltage value and current value and thus visual information (e.g., a text, an image, and/or an icon) corresponding to the image data may be displayed through the display 410.

According to an embodiment, the display module 160 may include a touch circuit 450. The touch circuit 450 may include a touch sensor 451 and a touch sensor IC 453 for controlling the touch sensor 451.

According to an embodiment, the touch sensor IC 453 may control the touch sensor 451 to detect a touch input or a hovering input in a predetermined position of the display 410. For example, the touch sensor IC 453 may measure a change in a signal (e.g., a voltage, a light amount, resistance, or a voltage amount) for a predetermined position of the display 410 to detect a touch input or a hovering input. The touch sensor IC 453 may provide information on the detected touch input or hovering input (e.g., a position, an area, a pressure, or a time) to the processor (e.g., the processor 120 in FIG. 1).

According to an embodiment, at least a portion (e.g., the touch sensor IC 453) of the touch circuit 450 may be included as a portion of the DDIC 430 or the display 410.

According to an embodiment, at least a portion (e.g., the touch sensor IC 453) of the touch circuit 450 may be included as a portion of other components (e.g., the auxiliary processor 123) disposed outside the display module 160.

According to an embodiment, the display module 160 may further include at least one sensor (e.g., a gesture sensor, a grip sensor, a color sensor, an infrared (IR) sensor, an illuminance sensor, an ultrasonic sensor, an iris recognition sensor, or a distance detection sensor (e.g., a time of flight (TOF) sensor or a light detection and ranging (LiDAR) sensor)) of the sensor module 176 (e.g., the sensor module 176 in FIG. 1) and/or a control circuit for controlling the sensors.

According to an embodiment, the display module 160 may further include at least one sensor (e.g., a barometric sensor, a magnetic sensor, a 6-axis sensor, a geomagnetic sensor, an accelerometer, a biometric sensor, a temperature sensor, a humidity sensor, or a fingerprint recognition sensor) of the sensor module 176 (e.g., the sensor module 176 in FIG. 1) and/or a control circuit (or control circuit module) for controlling the sensors.

In this case, the at least one sensor or the control circuit (or control circuit module) therefor may be embedded in a portion (e.g., the display 410 or the DDIC 430) of the display module 160 or a portion of the touch circuit 450.

According to an embodiment, in case that the sensor module 176 embedded in the display module 160 includes a color sensor, an infrared (IR) sensor, an illuminance sensor, and/or a light detection and ranging (LiDAR) sensor, the processor 120 may sense the illuminance and/or the IR strength around the electronic device (e.g., the electronic device 101 in FIG. 1, the electronic device 200 in FIGS. 2A and 2B, or the electronic device 300 in FIGS. 3A and 3B). The processor 120 may obtain information about the illuminance and information about the IR strength around the electronic device 101, 200, or 300. For example, the processor 120, based on the information about the illuminance and the information about the IR strength around the electronic device 101, 200, or 300, may control an operation of the DDIC 430 to change (e.g., adjust or control) the color temperature of the display 410. The DDIC 430 may change (e.g., adjust or control) the color temperature of the display 410, based on the control of the processor 120.

According to an embodiment, in case that the sensor module 176 embedded in the display module 160 includes a color sensor, an infrared (IR) sensor, an illuminance sensor, and/or a light detection and ranging (LiDAR) sensor, the processor 120 may sense the type of the light around the electronic device 101, 200, or 300. The processor 120 may obtain information about the type of the light (or light source) around the electronic device 101, 200, or 300. For example, the processor 120, based on the information about the light (or light source) around the electronic device 101, 200, or 300, may control an operation of the DDIC 430 to change (e.g., adjust or control) the color temperature of the display 410. The DDIC 430 may change (e.g., adjust or control) the color temperature of the display 410 based on the control of the processor 120.

According to an embodiment, the processor (e.g., the processor 120 in FIG. 1) of the electronic device 101, 200, or 300 may operate one or more cameras (e.g., an image sensor) and sense the color temperature around the electronic device 101, 200, or 300. The processor 120 may obtain a color temperature value around the electronic device 101, 200, or 300. For example, the processor 120, based on the information about the color temperature value around the electronic device 101, 200, or 300, may control an operation of the DDIC 430 to change (e.g., adjust or control) the color temperature of the display 410. The DDIC 430 may change (e.g., adjust or control) the color temperature of the display 410 based on the control of the processor 120.

FIG. 4B is a block view illustrates a display module according to an embodiment of the disclosure.

The display module 160 described in FIG. 4B may be at least partially similar or identical to the display module 160 described in FIG. 1 and/or the display module 160 described in FIG. 4A. The display module 160 described in FIG. 4B may include an embodiment different from that of the display module 160 described in FIG. 1 and/or the display module 160 described in FIG. 4A.

Referring to FIG. 4B, the display module 160 may include a display 410 (e.g., the display module 160 in FIG. 1, the display 230 and 235 in FIGS. 2A and 2B, or the display 301 in FIG. 3A), a DDIC 430 configured to drive the display 410, and a power supply device 460 configured to supply power (ELVDD or ELVSS) to the display 410.

According to an embodiment, the display 410 may include a display substrate and an active layer disposed on the display substrate and displaying an image.

According to an embodiment, the DDIC 430 may include memory 433, a data controller 4320, a gate controller 4330, and a timing controller 4340.

By way of example, at least a portion of the memory 433, the data controller 4320, the gate controller 4330, and the timing controller 4340 may be included in the DDIC 430.

By way of example, at least a portion of the memory 433, the data controller 4320, the gate controller 4330, and the timing controller 4340 may be included in the display 410.

According to an embodiment, the display 410 may include multiple gate lines GL and multiple data lines DL. For example, the multiple gate lines GL may be arranged in a first direction (e.g., the x-axis direction or the horizontal direction in FIG. 4B) and arranged at designated intervals. For example, the multiple data lines DL may be arranged in a second direction (e.g., the y-axis direction or the vertical direction in FIG. 4B) substantially perpendicular to the first direction and arranged at designated intervals.

In an embodiment of the disclosure, “a scan direction of the display 410” may be defined as a direction perpendicular to the direction in which the gate lines GL are arranged. For example, in case that the multiple gate lines GL are arranged in the first direction (e.g., the horizontal direction in FIG. 4B), the scan direction of the display 410 may be defined as the second direction (e.g., the y-axis direction or the vertical direction in FIG. 4B) substantially perpendicular to the first direction.

According to an embodiment, a pixel P may be disposed on each partial area of the display 410 on which the multiple gate lines GL and the multiple data lines intersect.

According to an embodiment, each pixel P may be electrically connected to a gate line GL and a data line DL to display a gray scale.

According to an embodiment, the power supply device 460 may generate driving voltage (ELVDD or ELVSS) to cause multiple pixels P arranged on the display 410 to emit light. The power supply device 460 may supply the driving voltage (ELVDD or ELVSS) to the display 410.

According to an embodiment, the pixels P may receive scan signals and light-emitting signals through the gate line GL and receive data signals through the data line DL. According to an embodiment, the pixels P may receive a high potential voltage (e.g., an ELVDD voltage) and a low potential voltage (e.g., an ELVSS voltage) as a power source to drive a micro light emitting diode (micro-LED) (or organic light emitting diode (OLED)).

According to an embodiment, each pixel P may include the OLED (or micro-LED) and a pixel driving circuit (e.g., multiple transistors or multiple capacitors) for driving the OLED (or micro-LED).

According to an embodiment, the pixel driving circuit disposed on each pixel P may control turning on (e.g., activated state) or off (e.g., deactivated state) of the OLED (or micro-LED), based on the scan signals and the light-emitting signals.

According to an embodiment, in a turn-on state (e.g., activated state), the OLED (or micro-LED) may display a gray scale (e.g., luminance) corresponding to the data signals for a period of one frame (or a portion of a period of one frame).

According to an embodiment, the data controller 4320 may drive the multiple data lines DL. According to an embodiment, the data controller 4320 may receive at least one synchronization signal and a data signal (e.g., digital image data) from the timing controller 4340 or the processor (e.g., the processor 120 in FIG. 1). According to an embodiment, the data controller 4320 may use a reference gamma voltage and a designated gamma curve to determine a data voltage (data) (e.g., analog video data) corresponding to the input data signal. According to an embodiment, the data controller 4320 may apply the data voltage (data) to the multiple data lines DL so as to supply the data voltage (data) to each pixel P.

The data controller 4320 may receive, from the timing controller 4340 or the processor (e.g., the processor 120 in FIG. 1), multiple synchronization signals having an identical frequency in a unit of frame. For example, a consecutive first frame and second frame may be driven based on multiple synchronization signals having an identical frequency.

According to an embodiment, the data controller 4320 may receive, from the timing controller 4340 or the processor (e.g., the processor 120 in FIG. 1), multiple synchronization signals having different frequencies in units of frame. For example, a consecutive first frame and second frame may be driven based on multiple synchronization signals having different frequencies.

According to an embodiment, the gate controller 4330 may receive at least one synchronization signal from the timing controller 4340 or the processor (e.g., the processor 120 in FIG. 1).

According to an embodiment, each gate line GL may include scan signal lines SCL to which scan signals are applied and light-emitting signal lines EML to which light-emitting signals are applied.

According to an embodiment, the gate controller 4330 may include a scan controller 4331 configured to consecutively generate multiple scan signals based on the synchronization signal and supply the generated multiple scan signals to a scan signal line SCL.

According to an embodiment, the gate controller 4330 may further include a light-emitting controller 4332 configured to consecutively generate multiple light-emitting signals based on the synchronization signal and supply the generated multiple light-emitting (EM) signals to the light-emitting signal line EML.

According to an embodiment, the timing controller 4340 may control driving timing of the data controller 4320 and the gate controller 4330. According to an embodiment, the timing controller 4340 may receive data signals in units of one frame from the processor (e.g., the processor 120 in FIG. 1). According to an embodiment, the timing controller 4340 may convert the data signal (e.g., digital image data) input from the processor 120 to correspond to resolution of the display 410 and supply the converted data signal to the data controller 4320.

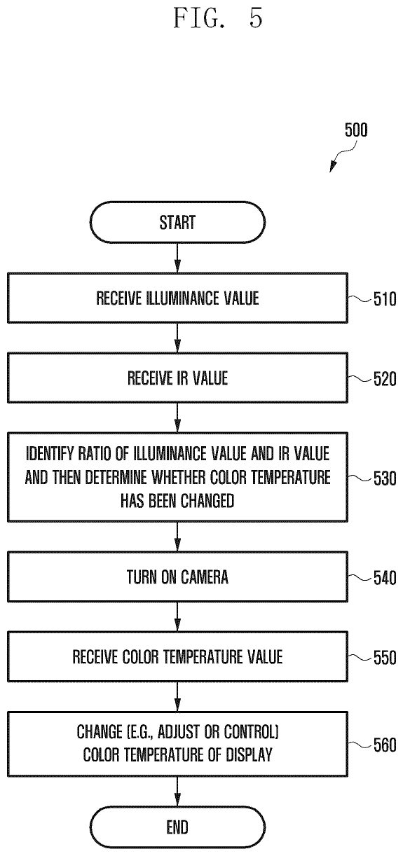

FIG. 5 is a flowchart 500 illustrating an operating method of an electronic device according to an embodiment of the disclosure.

Referring to FIG. 5, an electronic device (e.g., the electronic device 101 in FIG. 1, the electronic device 200 in FIGS. 2A and 2B, or the electronic device 300 in FIGS. 3A and 3B) may include a processor (e.g., the processor 120 in FIG. 1), memory (e.g., the memory 130 in FIG. 1), a display module (e.g., the display module 160 in FIG. 1 or the display module 160 in FIGS. 4A and 4B), a sensor module (e.g., the sensor module 176 in FIG. 1, the sensor modules 217a, 217b, and 226 in FIGS. 2A and 2B, or the sensor modules 304 and 319 in FIGS. 3A and 3B), and a camera module (e.g., the camera module 180 in FIG. 1, the camera module 216a, 216b, or 225 in FIGS. 2A and 2B, or the camera module 305 or 312 in FIGS. 3A and 3B). For example, the sensor module 176, 217a, 217b, 226, 304, or 319 may include a gesture sensor, a grip sensor, a color sensor, an infrared (IR) sensor, a luminance sensor, a magnetic sensor (e.g., a 6-axis sensor, or a geomagnetic sensor), an acceleration sensor, an ultrasonic sensor, an iris recognition sensor, or a distance detection sensor (e.g., a time of flight (TOF) sensor, a light detection and ranging (LiDAR) sensor) and/or a control circuit for the sensors.

According to an embodiment, the electronic device 101, 200, or 300 according to an embodiment of the disclosure may change (e.g., adjust or control) the color temperature of the display (e.g., the display module 160 in FIG. 1, the display 230 or 235 in FIGS. 2A and 2B, the display 301 in FIG. 3A, or the display 410 in FIGS. 4A and 4B), based on the information about the illuminance and the information about the IR strength around.

In operation 510, the processor 120 may operate the sensor module 176, 217a, 217b, 226, 304, or 319 (e.g., turn on the sensor module) and sense the illuminance around the electronic device 101, 200, or 300. The processor 120 may obtain information about the illuminance around the electronic device 101, 200, or 300 from the sensor module 176, 217a, 217b, 226, 304, or 319.

In operation 520, the processor 120 may operate the sensor module 176, 217a, 217b, 226, 304, or 319 (e.g., turn on the sensor module) and sense the IR strength around the electronic device 101, 200, or 300. The processor 120 may obtain information about the IR strength around the electronic device 101, 200, or 300 from the sensor module 176, 217a, 217b, 226, 304, or 319.

For example, the processor 120 may concurrently perform operation 510 and operation 520. For example, the processor 120 may consecutively perform operation 510 and operation 520. For example, the processor 120 may perform operation 510 and operation 520 in parallel.

In operation 530, the processor 120 may identify a ratio of an illuminance value and an IR strength value based on the information about the illuminance and the information about the IR strength around the electronic device 101, 200, or 300. Thereafter, the processor 120 may determine whether the color temperature of the display 160, 230, 235, or 410 has been changed.

In operation 540, the processor 120 may turn on an operation of the camera module 180, 216a, 216b, 225, 305, or 312 disposed in the electronic device 101, 200, or 300 (e.g., activate camera operation) to sense the color temperature value around the electronic device 101, 200, or 300. The camera module 180, 216a, 216b, 225, 305, or 312 may sense the color temperature value around the electronic device 101, 200, or 300 based on control of the processor 120. The camera module 180, 216a, 216b, 225, 305, or 312 may provide the color temperature value around the electronic device 101, 200, or 300 to the processor 120.

For example, the processor 120 may turn on operations of all (e.g., the entire) camera modules 180, 216a, 216b, 225, 305, and 312 disposed in the electronic device 101, 200, or 300 (e.g., turn on camera operation).

For example, the processor 120 may selectively turn on at least one of the camera modules 180, 216a, 216b, 225, and 305, and 312 disposed in the electronic device 101, 200, or 300 (e.g., turn on camera operation).

For example, the processor 120 may selectively turn on at least one camera module 180, 216a, or 305 disposed on a first surface (e.g., the front surface) of the electronic device 101, 200, or 300 among the camera modules 180, 216a, 216b, 225, 305, and 312 disposed in the electronic device 101, 200, or 300 (e.g., activate camera operation).

For example, the processor 120 may selectively turn on at least one camera module 180, 216b, 225, or 312 disposed on a second surface (e.g., the rear surface) of the electronic device 101, 200, or 300 among the camera modules 180, 216a, 216b, 225, 305, and 312 disposed in the electronic device 101, 200, or 300 (e.g., activate camera operation).

For example, the processor 120 may selectively turn on at least one camera module 180, 216a, or 305 disposed on the first surface (e.g., the front surface) and at least one camera module 180, 216b, 225, or 312 disposed on the second surface (e.g., the rear surface) of the electronic device 101, 200, or 300 among the camera modules 180, 216a, 216b, 225, 305, and 312 disposed in the electronic device 101, 200, or 300 (e.g., activate camera operation).

In operation 550, the processor 120 may obtain the color temperature value around the electronic device 101, 200, or 300 from the camera module 180, 216a, 216b, 225, 305, or 312.

For example, the processor 120 may obtain the color temperature value around the electronic device 101, 200, or 300 from all (e.g., the entire) camera modules 180, 216a, 216b, 225, 305, and 312 disposed in the electronic device 101, 200, or 300.

For example, the processor 120 may obtain the color temperature value around the electronic device 101, 200, or 300 from at least one camera module 180, 216a, 216b, 225, 305, or 312 among the camera modules 180, 216a, 216b, 225, 305, and 312 disposed in the electronic device 101, 200, or 300.

For example, the processor 120 may obtain the color temperature value around the electronic device 101, 200, or 300 from at least one camera module 180, 216a, or 305 disposed on the first surface (e.g., the front surface) of the electronic device 101, 200, or 300 among the camera modules 180, 216a, 216b, 225, 305, and 312 disposed in the electronic device 101, 200, or 300.

For example, the processor 120 may obtain the color temperature value around the electronic device 101, 200, or 300 from at least one camera module 180, 216b, 225, or 312 disposed on the second surface (e.g., the rear surface) of the electronic device 101, 200, or 300 among the camera modules 180, 216a, 216b, 225, 305, and 312 disposed in the electronic device 101, 200, or 300.

For example, the processor 120 may obtain the color temperature value around the electronic device 101, 200, or 300 from at least one camera module 180, 216a, or 305 disposed on the first surface (e.g., the front surface) and at least one camera module 180, 216b, 225, or 312 disposed on the second surface (e.g., the rear surface) of the electronic device 101, 200, or 300 among the camera modules 180, 216a, 216b, 225, 305, and 312 disposed in the electronic device 101, 200, or 300.

In operation 560, the processor 120 may change (e.g., adjust or control) the color temperature of the display 160, 230, 235, 301, or 410, based on the color temperature value around the electronic device 101, 200, or 300. For example, the processor 120 may control an operation of the DDIC (e.g., the DDIC 430 in FIGS. 4A and 4B) to change (e.g., adjust or control) the color temperature of the display 160, 230, 235, 301, or 410. The DDIC 430 may change (e.g., adjust or control) the color temperature of the display 160, 230, 235, 301, or 410 based on the control of the processor 120.

For example, operations of the processor 120 may be performed by loading instructions stored in the memory (e.g., the memory 130 in FIG. 1).

According to an embodiment, the memory 130 may include main memory and storage (or auxiliary memory). The main memory may include volatile memory, such as dynamic random-access memory (DRAM), static RAM (SRAM), or synchronous dynamic RAM (SDRAM). The storage may include at least one of one-time programmable ROM (OTPROM), PROM, EPROM, EEPROM, mask ROM, flash ROM, flash memory, a hard drive, or a solid-state drive (SSD).

According to an embodiment, the memory 130 may correspond to non-volatile memory and include a large capacity storage. For example, the memory 130 may include at least one of one-time programmable ROM (OTPROM), PROM, EPROM, EEPROM, mask ROM, flash ROM, flash memory, a hard drive, or a solid-state drive (SSD). The memory 130 may store various types of file data and the stored file data may be updated according to an operation of the processor 120.

For example, the memory 130 may include instructions for performing an operation of the processor 120. In addition, the memory 130 may include instructions for performing operations of the display module 160, the sensor module 176, 217a, 217b, 226, 304, or 319, the camera module 180, 216a, 216b, 225, 305, or 312, and the communication module (e.g., the communication module 190 in FIG. 1).

For example, a portion of operations 510 to 560 described in FIG. 5 may be omitted. Before or after the at least a portion of the operations illustrated in FIG. 5 may be added and/or inserted at least a portion of the operations described herein with reference to other drawings.

For example, operations 510 to 560 described in FIG. 5 may be consecutively performed. For example, operations 510 to 560 described in FIG. 5 may be performed in parallel. For example, some operations among operations 510 to 560 described in FIG. 5 may be consecutively performed and some operations may be performed in parallel.

For example, the memory 130 may store instructions to cause the processor 120 to perform operations 510 to 560 described in FIG. 5.

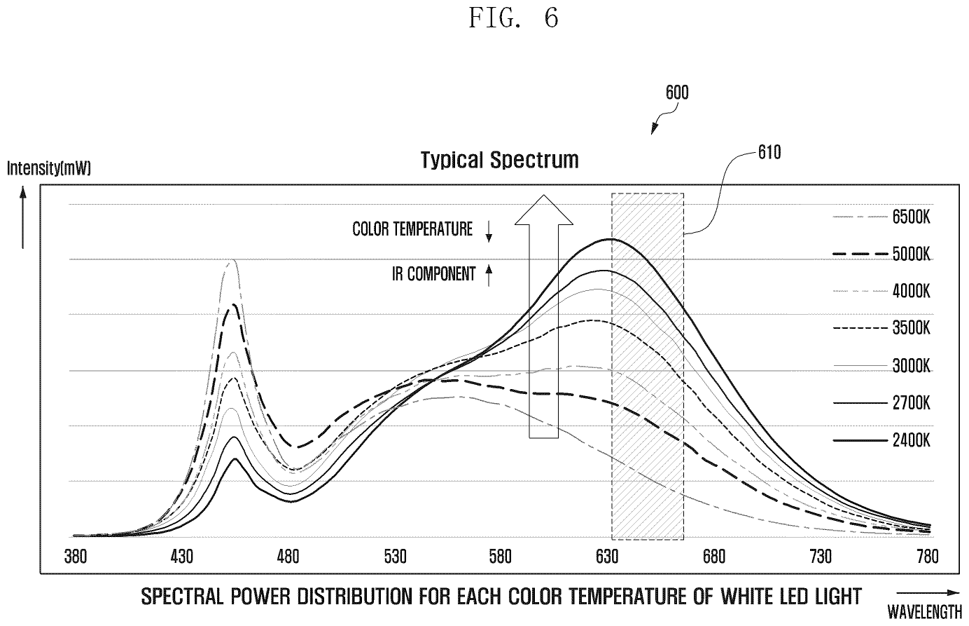

FIG. 6 is a view 600 illustrating a spectral power distribution (SPD) for each color temperature of a light (or light source) according to an embodiment of the disclosure.

Referring to FIG. 6, in the graph depicting the spectral power distribution (SPD) for each color temperature of the light (or light source) (e.g., an LED lamp), as the color temperature of the light (or light source) (e.g., an LED lamp) decreases, the intensity of an IR wavelength band 610 (e.g., 630 nm to 650 nm) may increase. By using an IR wavelength band and the tendency of the color temperature of the light (or light source), it is possible to detect changes in the color temperature of the light (or light source). Here, IR values and illuminance values may be considered together as factors that affect the color temperature of the light (or light source).

According to an embodiment of the disclosure, the electronic device (e.g., the electronic device 101 in FIG. 1, the electronic device 200 in FIGS. 2A and 2B, or the electronic device 300 in FIGS. 3A and 3B) may obtain a color temperature value by using the camera module (e.g., the camera module 180 in FIG. 1, the camera module 216a, 216b, or 225 in FIGS. 2A and 2B, or the camera module 305 or 312 in FIGS. 3A and 3B). Here, when obtaining the color temperature value, the electronic device 101, 200, or 300 may not use the sensor module (e.g., the sensor module 176 in FIG. 1, the sensor modules 217a, 217b, and 226 in FIGS. 2A and 2B, or the sensor modules 304 and 319 in FIGS. 3A and 3B).

In this case, the color temperature value may only be obtained when the camera module 180, 216a, 216b, 225, 305, or 312 is turned on (e.g., camera operation on), so the camera module 180, 216a, 216b, 225, 305, or 312 needs to always be turned on (e.g., camera operation on). The turning on operation of the camera modules 180, 216a, 216b, 225, 305, or 312 may increase the power consumption of the electronic devices 101, 200, or 300. The turning on operation of the camera module 180, 216a, 216b, 225, 305, or 312 needs to be reduced to reduce the power consumption of the electronic device 101, 200, or 300. Accordingly, in order to reduce the power consumption of the electronic device 101, 200, or 300 and increase efficiency of color temperature change (e.g., adjustment or control) of the display (e.g., the display module 160 in FIG. 1, the display 230 or 235 in FIGS. 2A and 2B, the display 301 in FIG. 3A, or the display 410 in FIGS. 4A and 4B), the sensor module 176, 217a, 217b, 226, 304, or 319 and the camera module 180, 216a, 216b, 225, 305, or 312 may be used.

According to an embodiment of the disclosure, the electronic device 101, 200, or 300 may operate the sensor module 176, 217a, 217b, 226, 304, or 319 and obtain the illuminance value and the IR value around the electronic device 101, 200, or 300.

For example, the processor (e.g., the processor 120 in FIG. 1) of the electronic device 101, 200, or 300 may obtain the illuminance value and the IR value around the electronic device 101, 200, or 300 by using an illuminance sensor, an IR sensor, and/or a color sensor disposed on a first surface (e.g., a surface on which a screen is displayed) of the display 160, 230, 235, 301, or 410, among the sensor module 176, 217a, 217b, 226, 304, or 319 disposed in the electronic device 101, 200, or 300.

For example, the processor 120 of the electronic device 101, 200, or 300 may obtain the illuminance value and the IR value around the electronic device 101, 200, or 300 by using an illuminance sensor, an IR sensor, and/or a color sensor disposed on a second surface (e.g., a surface opposite to the surface on which a screen is displayed) of the display 160, 230, 235, 301, or 410, among the sensor module 176, 217a, 217b, 226, 304, or 319 disposed in the electronic device 101, 200, or 300.

For example, the processor 120 of the electronic device 101, 200, or 300 may obtain the illuminance value and the IR value around the electronic device 101, 200, or 300 by using an illuminance sensor, an IR sensor, and/or a color sensor disposed on the first surface (e.g., a surface on which a screen is displayed) and the second surface (e.g., a surface opposite to the surface on which a screen is displayed) of the display 160, 230, 235, 301, or 410, among the sensor module 176, 217a, 217b, 226, 304, or 319 disposed in the electronic device 101, 200, or 300.

The obtaining of the illuminance value and the IR value around the electronic device 101, 200, or 300 may be performed before sensing the color temperature value around the electronic device 101, 200, or 300. In order to determine whether and when the camera module 180, 216a, 216b, 225, 305, or 312 is operated, the illuminance value and the IR value around the electronic device 101, 200, or 300 may be obtained. According to an embodiment, the processor 120 may determine, based on the illuminance value and IR value around the electronic device 101, 200, or 300, whether the color temperature (e.g., the light (or light source)) around the electronic device 101, 200, or 300 has been changed. In case of determining that the color temperature has been changed, the processor 120 may selectively operate the camera module 180, 216a, 216b, 225, 305, or 312.

According to an embodiment, the processor 120 may determine, based on the illuminance value and IR value around the electronic device 101, 200, or 300, the color temperature change (e.g., the light (or light source)) around the electronic device 101, 200, or 300.

According to an embodiment, the processor 120 may determine sense that the color temperature (e.g., the light (or light source)) around the electronic device 101, 200, or 300 has been changed. In case of determining of the color temperature change (e.g., the light (or light source)) around the electronic device 101, 200, or 300, the processor 120 may selectively operate the camera module 180, 216a, 216b, 225, 305, or 312 at a time point at which the color temperature of the light (or light source) is changed so as to obtain the color temperature value around the electronic device 101, 200, or 300.

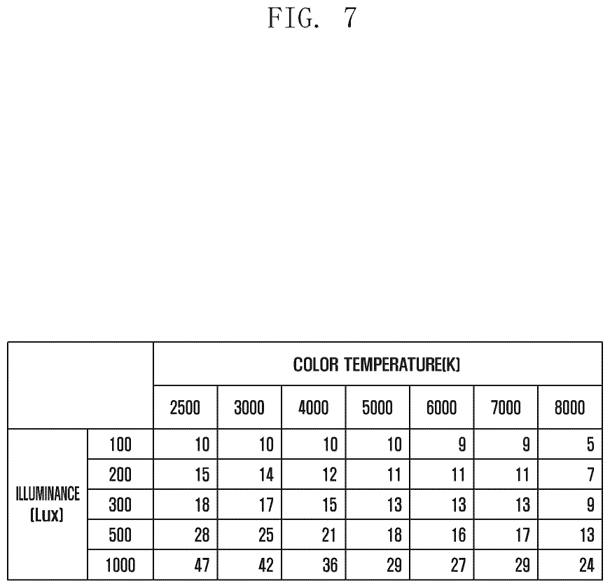

FIG. 7 is a view illustrating an infrared ray (IR) sensing value according to an illuminance and a color temperature around an electronic device according to an embodiment of the disclosure.

Referring to FIG. 7, the IR value and the illuminance value of the light (or light source) affects the color temperature, and thus the IR value and the illuminance value of the light (or light source) may be used together when obtaining the color temperature value around the electronic device 101, 200, or 300.

For example, when the color temperature of the light (or light source) is 2500 k, the IR value may increase from 100 Lux to 1000 Lux of illuminance.

For example, when the color temperature of the light (or light source) is 3000 k, the IR value may generally increase from 100 lux to 1000 lux of illuminance.

For example, when the color temperature of the light (or light source) is 4000 k, the IR value may increase from 100 Lux to 1000 Lux of illuminance.

For example, when the color temperature of the light (or light source) is 5000 k, the IR value may increase from 100 Lux to 1000 Lux of illuminance.

For example, when the color temperature of the light (or light source) is 6000 k, the IR value may increase from 100 Lux to 1000 Lux of illuminance.

For example, when the color temperature of the light (or light source) is 7000 k, the IR value may increase from 100 Lux to 1000 Lux of illuminance.

For example, when the color temperature of the light (or light source) is 8000 k, the IR value may increase from 100 Lux to 1000 Lux of illuminance.

According to an embodiment, the illuminance value of the light (or light source) may be configured as a control variable and the color temperature value may be configured as an independent variable. When data is collected by configuring the illuminance value of the light (or light source) as the control variable and the color temperature value as the independent variable, it may be seen that IR values vary depending on the color temperature value. Through this, at an identical illumination value, the color temperature value may be roughly inferred from the IR value.

The processor (e.g., the processor 120 of FIG. 1) may determine whether the condition of Equation 1 below is satisfied (e.g., a ratio of a current illuminance value to an IR value is different from a ratio of a previous illuminance value to an IR value). The processor 120 may determine whether the color temperature around the electronic device (e.g., the electronic device 101 of FIG. 1, the electronic device 200 of FIGS. 2A and 2B, or the electronic device 300 of FIGS. 3A and 3B) has been changed, based on whether the condition of Equation 1 is satisfied (e.g., the ratio of the current illuminance value to the IR value is different from the ratio of the previous illuminance value to the IR value).

$$\frac{IR}{Lux} \neq \frac{prev \cdot IR}{prev \cdot Lux} \qquad Equation 1$$

In Equation 1, “IR” may represent the IR value, “Lux” may represent the illuminance value. In addition, “prev. IR” may represent the previous IR value, and “prev. Lux” may represent the previous illuminance value.

According to an embodiment, the processor 120 may sense the illuminance value (e.g., the previous illuminance value (prev. Lux)) and the IR value (e.g., the previous IR value (prev. IR)) of the light (or light source) around the electronic device 101, 200, or 300 at a first time point. The processor 120 may sense the illuminance value (e.g., the current illuminance value (Lux)) and the IR value (e.g., the current IR value (IR)) of the light (or light source) around the electronic device 101, 200, or 300 at a second time point.

The processor 120 may determine whether the condition of Equation 1 above is satisfied (e.g., the ratio of the current illuminance value to the IR value is different from the ratio of the previous illuminance value to the IR value).

For example, in case that the ratio of the current illuminance value to the IR value is different from the ratio of the previous illuminance value to the IR value, the processor 120 may determine that the color temperature (e.g., the color temperature value) around the electronic device 101, 200, or 300 has been changed.

For example, in case that the color temperature (e.g., the color temperature value) around the electronic device 101, 200, or 300 has been changed, the processor 120 may selectively operate the camera module 180, 216a, 216b, 225, 305, or 312 to obtain the color temperature value around the electronic device 101, 200, or 300 so that the processor 120 may accurately sense the color temperature value around the electronic device 101, 200, or 300.

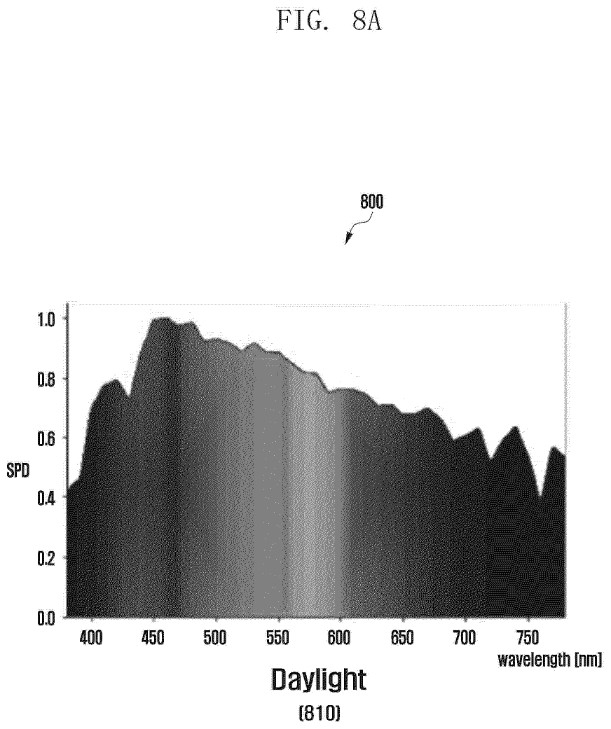

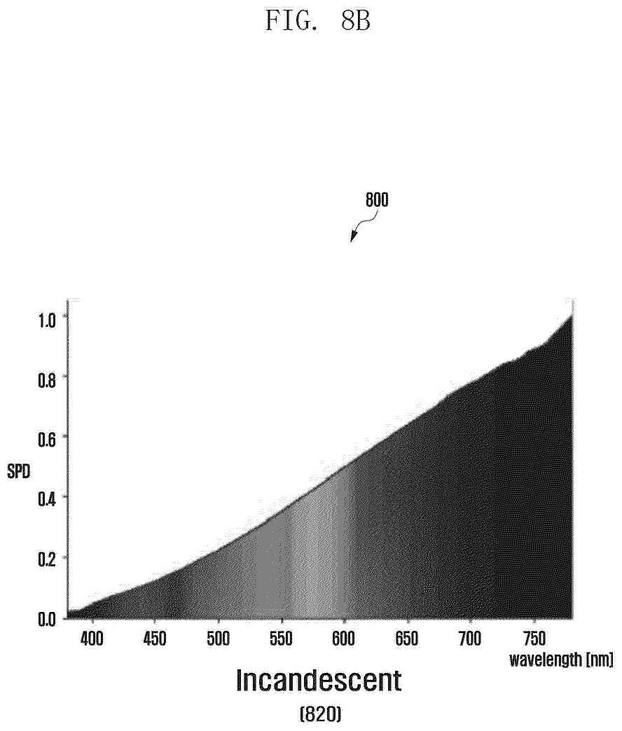

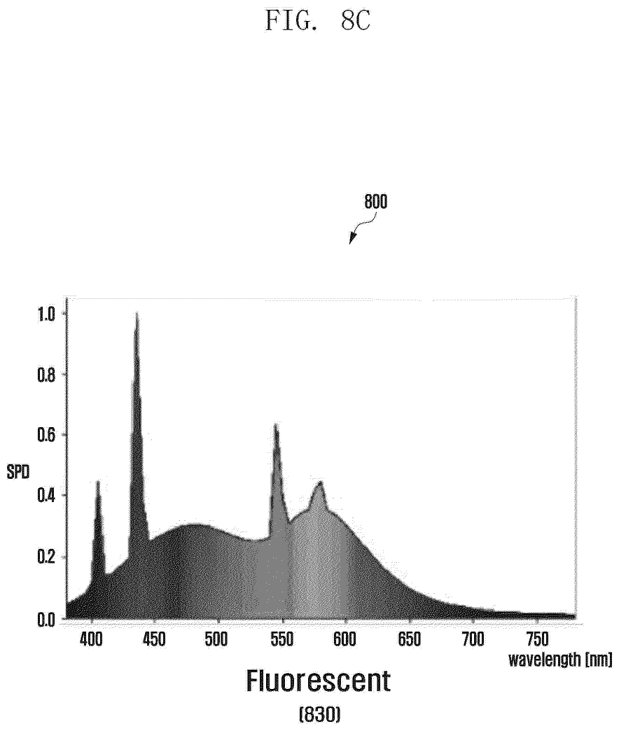

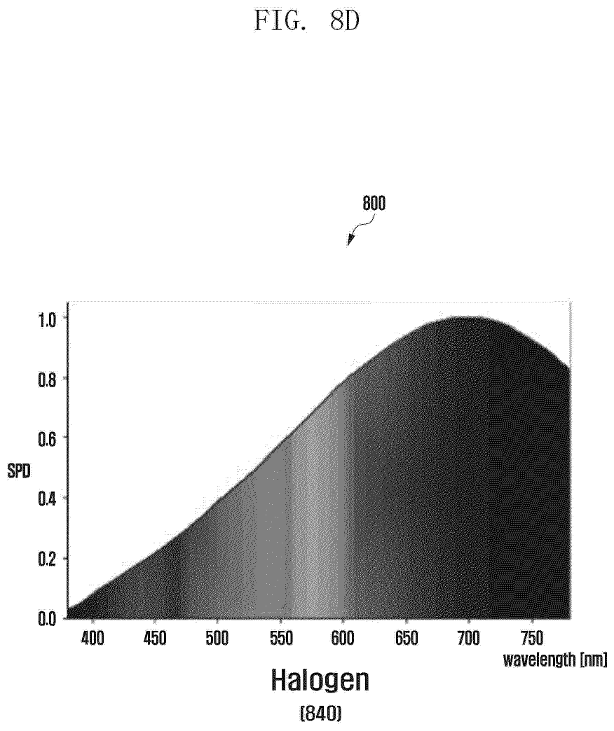

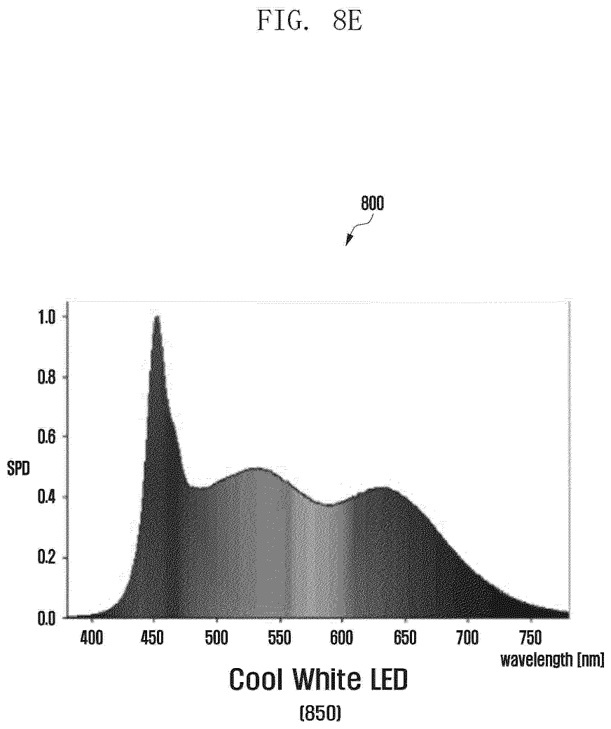

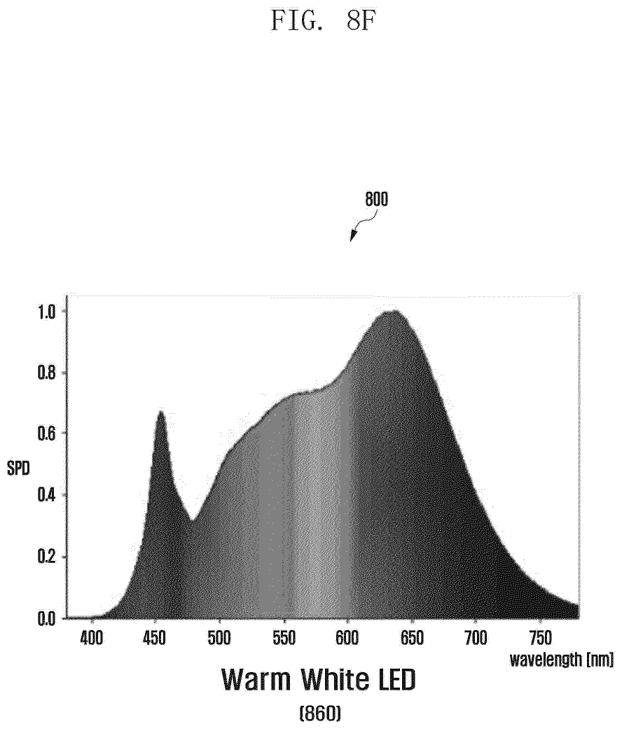

FIGS. 8A to 8F are views 800 illustrating a spectral power distribution (SPD) according to a type of light (or light source) according to various embodiments of the disclosure.

Referring to FIGS. 8A to 8F, according to an embodiment, FIG. 8A illustrates a spectral power distribution (SPD) for each wavelength band of the sunlight 810 (e.g., daylight). FIG. 8B illustrates a spectral power distribution (SPD) for each wavelength band of an incandescent lamp 820. FIG. 8C illustrates a spectral power distribution (SPD) for each wavelength band of a fluorescent lamp 830. FIG. 8D illustrates a spectral power distribution (SPD) for each wavelength band of a halogen lamp 840. FIG. 8E illustrates a spectral power distribution (SPD) for each wavelength band of a cool white light LED lamp 850. FIG. 8F illustrates a spectral power distribution (SPD) for each wavelength band of a warm white light LED lamp 860.

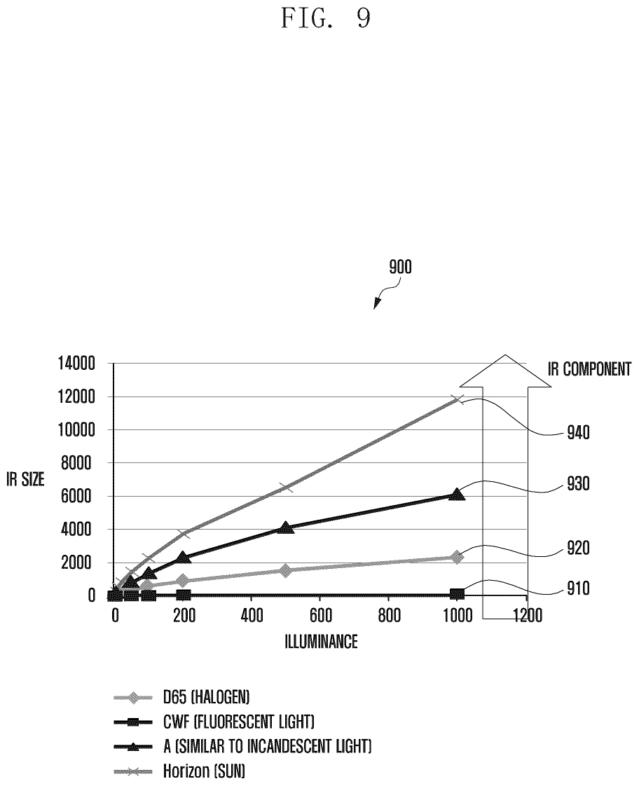

FIG. 9 is a view 900 illustrating data of a sensor module (e.g., an illuminance sensor) according to a type of light (or light source) according to an embodiment of the disclosure.

Referring to FIGS. 8A to 8F and 9, the power of the IR wavelength (e.g., 630 nm) component may vary depending on the type of light (or light source). For example, it may be identified that the spectral power distribution 910 of the fluorescent lamp 830, the spectral power distribution 920 of the halogen lamp 840, the spectral power distribution 930 of the incandescent lamp 820, and the spectral power distribution 940 of the sunlight 810 are different from each other. The fluorescent lamp 830 may have almost no IR value across the entire wavelength band (e.g., substantially no IR value).

For example, referring to the spectral power distribution 920 of the halogen lamp 840, it may be appreciated that as the illuminance increases, the IR value increases (e.g., the IR value increases to about 2200). Without limitation thereto, the IR value of the halogen lamp 840 may have a value of 2200 or more.

For example, referring to the spectral power distribution 930 of the incandescent lamp 820, it may be appreciated that as the illuminance increases, the IR value increases (e.g., the IR value increases to about 6000). Without limitation thereto, the IR value of the incandescent lamp 820 may have a value of 6000 or more.

For example, referring to the spectral power distribution 940 of the sunlight 810, it may be appreciated that as the illuminance increases, the IR value increases (e.g., the IR value increases to about 12000). Without limitation thereto, the IR value of the sunlight 810 may have a value of 12000 or more.

For example, referring to the spectral power distribution 910 of the fluorescent lamp 830, it may be appreciated that the IR value is substantially 0 (e.g., substantially unchanged) regardless of the illuminance.

For example, considering the spectral power distributions 910, 920, 930, 940 of the lights, the change in IR value for each change in illuminance may be greater for the halogen lamp 840 than for the fluorescent lamp 830. The change in IR value for each change in illuminance may be greater for the halogen lamp 840 than for the incandescent lamp 820. The change in IR value for each change in illuminance may be greater for the sunlight 810 than for the incandescent lamp 820.

According to an embodiment, the processor (e.g., the processor 120 in FIG. 1) may determine a type of light (or light source), based on the IR value sensed by the IR sensor and the illuminance value sensed by the illuminance sensor disposed in the sensor module (e.g., the sensor module 176 in FIG. 1, the sensor modules 217a, 217b, and 226 in FIGS. 2A and 2B, or the sensor modules 304 and 319 in FIGS. 3A and 3B).

Different lights (or light sources) may have different IR values at a specific illuminance. Considering that different lights (or light sources) have different IR values at a specific illuminance, the processor 120 may match the IR value with the illuminance value. The processor 120 may determine the types of the lights (or light sources) based on the IR value at a specific illuminance.

For example, the processor 120, in case that the illuminance value of a specific light (or light source) is about 800 lux, the IR value is measured as about 2000, and when the illuminance value of a specific light (or light source) is about 1000 lux, the IR value is measured at about 2400, may determine the specific light (or light source) is standard light D65, and the type of light is a halogen lamp.

For example, the processor 120, in case that the illuminance value of a specific light (or light source) is about 800 lux, the IR value is measured as about 5000, and when the illuminance value of a specific light (or light source) is about 1000 lux, the IR value is measured at about 6000, may determine the specific light (or light source) is standard light A, and the type of light is an incandescent light.

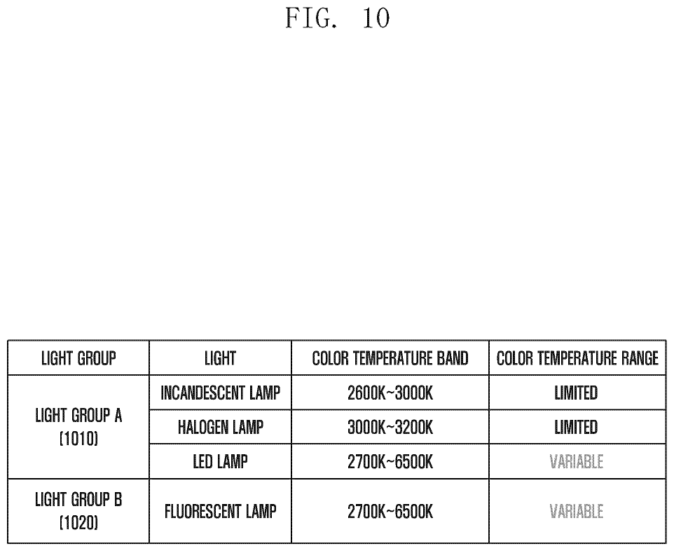

FIG. 10 is a view illustrating a color temperature band for each type of light (or light source) according to an embodiment of the disclosure.

Referring to FIG. 10, the processor (e.g., the processor 120 in FIG. 1) may match the IR values with the illuminance values of the lights (or light sources) and analyze the illuminance values and the IR values to classify the lights (or light sources).

According to an embodiment of the disclosure, the electronic device (e.g., the electronic device 101 in FIG. 1, the electronic device 200 in FIGS. 2A and 2B, or the electronic device 300 in FIGS. 3A and 3B) may consider the type of the light (or light source) by adding the illuminance value and the IR value of the light (or light source). The electronic device 101, 200, or 300 may determine the type of the light (or light source) and selectively operate the camera module 180, 216a, 216b, 225, 305, or 312 to obtain the color temperature value around the electronic device 101, 200, or 300 based on the type of the light (or light source).

According to an embodiment, the processor (e.g., the processor 120 in FIG. 1) may analyze the size of the IR value relative to the illuminance value of the light (or light source) and classify the lights (or light sources) roughly into two groups. The processor 120 may classify, based on the size of the IR value relative to the illuminance value of the lights (or light sources), lights (or light sources) of which the size of the IR value changes relative to the illuminance value into a first light group 1010 (e.g., light group A). For example, information about the first light group 1010 (e.g., light group A) may be stored in the memory (e.g., the memory 130 in FIG. 1) in a look-up table form.

For example, the processor 120 may classify, based on the magnitude of the IR value relative to the illuminance value of the lights (or light sources), the incandescent lamp (e.g., the incandescent lamp 820 in FIG. 8B), the halogen lamp (e.g., the halogen lamp 840 in FIG. 8D), and the LED lamp (e.g., the cool white light LED lamp 850 in FIG. 8E, the warm white light LED lamp 860 in FIG. 8F) into the first light group 1010 (e.g., light group A).

According to an embodiment, the processor 120 may classify, based on the size of the IR value relative to the illuminance value of the lights (or light sources), lights (or light sources) of which the size of the IR value does not change relative to the illuminance value into a second light group 1020 (e.g., light group B).

For example, the processor 120 may classify, based on the size of the IR value relative to the illuminance value of the lights (or light sources), the florescent lamp (e.g., the fluorescent lamp 830 in FIG. 8C) into the second light group 1020 (e.g., light group B). For example, information about the second light group 1020 (e.g., light group B) may be stored in the memory (e.g., the memory 130 in FIG. 1) in a look-up table form.

For example, the fluorescent lamp 830 has a wide color temperature band from 2700K to 6500K, which requires sensing of color temperature changes and changing (e.g., adjusting or controlling) the color temperature of the display (e.g., the display module 160 in FIG. 1, the displays 230 or 235 in FIGS. 2A and 2B, the display 301 in FIG. 3A, or the display 410 in FIGS. 4A and 4B) based on the color temperature changes.

For example, because the fluorescent lamp 830 has very little IR component (e.g., substantially no IR component) regardless of changes in illuminance value, it is difficult to sense a change in size of the IR value of the fluorescent lamp 830 according to changes in illuminance value. For example, the processor 120 may classify the fluorescent lamp 830 into the second light group 1020 (e.g., light group B) by reflecting the characteristic that the size of the IR value does not change depending on the illuminance value of the fluorescent lamp 830.

According to an embodiment, the processor 120, in case that the light (or light source) is classified into the first light group 1010 (e.g., light group A), may determine whether the ratio of the current illuminance value to the IR value (e.g., the second ratio) is different from the ratio of the previous illuminance value to the IR value (e.g., the first ratio). The processor 120, in case that the ratio of the current illuminance value to the IR value is different from the ratio of the previous illuminance value to the IR value, may determine that the color temperature (e.g., the color temperature value) around the electronic device 101, 200, or 300 has been changed. For example, the processor 120, in case that the color temperature value around the electronic device 101, 200, or 300 has been changed, may selectively operate the camera module 180, 216a, 216b, 225, 305, or 312 and obtain the color temperature value around the electronic device 101, 200, or 300. For example, the processor 120 may control, based on the color temperature value around the electronic device 101, 200, 300, an operation of the display driver IC (e.g., a display driving driver) (e.g., the DDIC 430 in FIGS. 4A and 4B) to change (e.g., adjust or control) the color temperature of the display 160, 230, 235, 301, or 410. For example, the processor 120 may, in case of determining that the color temperature value around the electronic device 101, 200, 300 has been changed, control an operation of the display driver IC (e.g., a display driving driver) (e.g., the DDIC 430 in FIGS. 4A and 4B) to change (e.g., adjust or control) the color temperature of the display 160, 230, 235, 301, or 410. For example, the DDIC 430 may change (e.g., adjust or control) the color temperature of the display 160, 230, 235, 301, or 410 based on the control of the processor 120.

According to an embodiment, the processor 120, in case that the light (or light source) is classified into the second light group 1020 (e.g., light group B), may selectively operate the camera module 180, 216a, 216b, 225, 305, or 312 at predetermined time (e.g., during the day) and obtain the color temperature value around the electronic device 101, 200, or 300. The electronic device 101, 200, or 300 may selectively operate the camera module 180, 216a, 216b, 225, 305, or 312 at predetermined time (e.g., during the day) so as to reduce power consumption. For example, the processor 120, in case that the light (or light source) is classified into the second light group 1020 (e.g., light group B), may not operate the camera module 180, 216a, 216b, 225, 305, or 312 at night (or late at night or bedtime). The electronic device 101, 200, or 300 may not operate the camera module 180, 216a, 216b, 225, 305, or 312 at night (or late at night or bedtime) so as to reduce power consumption.

According to an embodiment, the processor 120, in case that the light (or light source) is classified into the second light group 1020 (e.g., light group B), may selectively operate the camera module 180, 216a, 216b, 225, 305, or 312 at configured time intervals (e.g., 1 second interval, 10 second interval, 30 second interval, 1 minute interval, 15 minute interval, 30 minute interval, or 60 minute interval) and obtain the color temperature value around the electronic device 101, 200, or 300. The electronic device 101, 200, or 300 may selectively operate the camera module 180, 216a, 216b, 225, 305, or 312 at configured time intervals (e.g., 1 second interval, 10 second interval, 30 second interval, 1 minute interval, 15 minute interval, 30 minute interval, or 60 minute interval) so as to reduce power consumption.

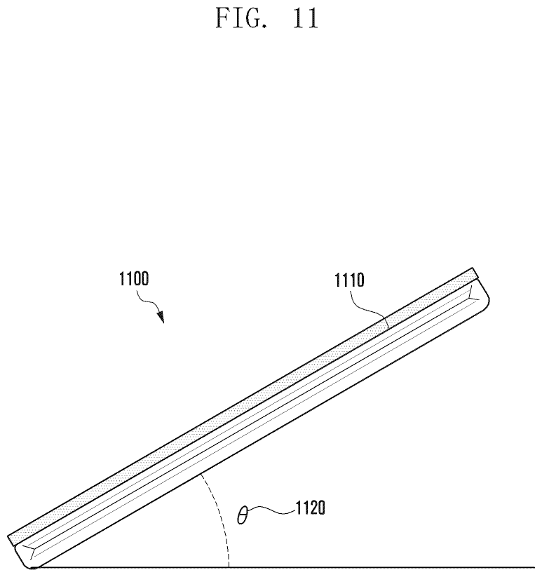

FIG. 11 is a view illustrating determining of turning on or off of cameras according to a posture (or angle) of an electronic device according to an embodiment of the disclosure.

Referring to FIG. 11, an electronic device 1100 (e.g., the electronic device 101 in FIG. 1, the electronic device 200 in FIGS. 2A and 2B, or the electronic device 300 in FIGS. 3A and 3B) may include a processor (e.g., the processor 120 in FIG. 1), memory (e.g., the memory 130 in FIG. 1), a display module (e.g., the display module 160 in FIG. 1 or the display module 160 in FIGS. 4A and 4B), a sensor module (e.g., the sensor module 176 in FIG. 1, the sensor modules 217a, 217b, and 226 in FIGS. 2A and 2B, or the sensor modules 304 and 319 in FIGS. 3A and 3B), and a camera module (e.g., the camera module 180 in FIG. 1, the camera module 216a, 216b, or 225 in FIGS. 2A and 2B, or the camera module 305 or 312 in FIGS. 3A and 3B). For example, the sensor module 176, 217a, 217b, 226, 304, or 319 may include a gesture sensor, a grip sensor, a color sensor, an infrared (IR) sensor, a luminance sensor, a magnetic sensor (e.g., a 6-axis sensor, or a geomagnetic sensor), an acceleration sensor, an ultrasonic sensor, an iris recognition sensor, or a distance detection sensor (e.g., a time of flight (TOF) sensor, a light detection and ranging (LiDAR) sensor) and/or a control circuit for the sensors.

According to an embodiment, the processor 120 may turn on an operation of the camera module 180, 216a, 216b, 225, 305, or 312 disposed in the electronic device 1100, 101, 200, or 300 (e.g., turn on camera operation) to sense the color temperature value around the electronic device 1100, 101, 200, or 300. The camera module 180, 216a, 216b, 225, 305, or 312 may sense the color temperature value around the electronic device 1100, 101, 200, or 300 based on control of the processor 120. The camera module 180, 216a, 216b, 225, 305, or 312 may provide the color temperature value around the electronic device 1100, 101, 200, or 300 to the processor 120.

For example, the processor 120 may turn on operations of all (e.g., the entire) camera modules 180, 216a, 216b, 225, 305, and 312 disposed in the electronic device 1100, 101, 200, or 300 (e.g., turn on camera operation).

For example, the processor 120 may selectively turn on at least one of the camera modules 180, 216a, 216b, 225, and 305, and 312 disposed in the electronic device 1100, 101, 200, or 300 (e.g., turn on camera operation).

According to an embodiment, at least one camera module may be disposed on the first surface (e.g., a surface on which a screen is displayed) and the second surface (e.g., a surface on which no screen is disposed, or a surface opposite to the first surface) of the electronic device 1100, 101, 200, or 300. The camera module 180, 216a, 216b, 225, 305, or 312 is operated to generate an image (e.g., an image is captured by a camera), and thus the color temperature value may be affected according to an angle between a captured subject and the camera.

For example, depending on a position and angle of the electronic device 1100, 101, 200, or 300 and/or a direction in which the electronic device 1100, 101, 200, or 300 is facing, an amount of light incident from the light (or light source) to the camera module 180, 216a, 216b, 225, 305, or 312 may vary. If there is no or very little light incident on the camera modules 180, 216a, 216b, 225, 305, 312, it is impossible for the electronic device 1100, 101, 200, 300 to accurately sense the color temperature around.

For example, the processor 120 may selectively turn on at least one camera module 180, 216a, or 305 disposed on a first surface (e.g., the front surface) of the electronic device 1100, 101, 200, or 300 among the camera modules 180, 216a, 216b, 225, 305, and 312 disposed in the electronic device 1100, 101, 200, or 300 (e.g., activate camera operation).

For example, the processor 120 may selectively turn on at least one camera module 180, 216b, 225, or 312 disposed on a second surface (e.g., the rear surface) of the electronic device 1100, 101, 200, or 300 among the camera modules 180, 216a, 216b, 225, 305, and 312 disposed in the electronic device 1100, 101, 200, or 300 (e.g., activate camera operation).

For example, the processor 120 may selectively turn on at least one camera module 180, 216a, or 305 disposed on the first surface (e.g., the front surface) and at least one camera module 180, 216b, 225, or 312 disposed on the second surface (e.g., the rear surface) of the electronic device 1100, 101, 200, or 300 among the camera modules 180, 216a, 216b, 225, 305, and 312 disposed in the electronic device 1100, 101, 200, or 300 (e.g., activate camera operation).

For example, the processor 120 may obtain the color temperature value around the electronic device 1100, 101, 200, or 300 from all (e.g., the entire) camera modules 180, 216a, 216b, 225, 305, and 312 disposed in the electronic device 1100, 101, 200, or 300.

For example, the processor 120 may obtain the color temperature value around the electronic device 1100, 101, 200, or 300 from at least one camera module 180, 216a, 216b, 225, 305, or 312 among the camera modules 180, 216a, 216b, 225, 305, and 312 disposed in the electronic device 1100, 101, 200, or 300.

For example, the processor 120 may obtain the color temperature value around the electronic device 1100, 101, 200, or 300 from at least one camera module 180, 216a, or 305 disposed on the first surface (e.g., the front surface) of the electronic device 1100, 101, 200, or 300 among the camera modules 180, 216a, 216b, 225, 305, and 312 disposed in the electronic device 1100, 101, 200, or 300.

For example, the processor 120 may obtain the color temperature value around the electronic device 1100, 101, 200, or 300 from at least one camera module 180, 216b, 225, or 312 disposed on the second surface (e.g., the rear surface) of the electronic device 1100, 101, 200, or 300 among the camera modules 180, 216a, 216b, 225, 305, and 312 disposed in the electronic device 1100, 101, 200, or 300.

For example, the processor 120 may obtain the color temperature value around the electronic device 1100, 101, 200, or 300 from at least one camera module 180, 216a, or 305 disposed on the first surface (e.g., the front surface) and at least one camera module 180, 216b, 225, or 312 disposed on the second surface (e.g., the rear surface) of the electronic device 1100, 101, 200, or 300 among the camera modules 180, 216a, 216b, 225, 305, and 312 disposed in the electronic device 1100, 101, 200, or 300.

For example, the electronic devices 1100, 101, 200, 300 need to sense the color temperature around, but capturing a subject that has a specific color (e.g., human skin, an object (or a wall or a bottom surface of a table) that is painted a specific color) will prevent the electronic devices 101, 200, 300 from accurately sensing the color temperature around.

For example, the processor 120 may operate a color sensor, an infrared (IR) sensor, a light sensor, a gesture sensor, a magnetic sensor (e.g., a 6-axis sensor or a geomagnetic sensor), an acceleration sensor, a distance detection sensor, and/or a LiDAR sensor disposed in the sensor module 176, 217a, 217b, 226, 304, or 319.

For example, the sensor module 176, 217a, 217b, 226, 304, or 319 may sense a position and angle of the electronic device 1100, 101, 200, or 300 and/or a direction in which the electronic device 1100, 101, 200, or 300 is facing, based on control of the processor 120. The sensor module 176, 217a, 217b, 226, 304, or 319 may obtain sensing information about the position and angle of the electronic device 1100, 101, 200, or 300 and/or the direction in which the electronic device 1100, 101, 200, or 300 is facing. The sensor module 176, 217a, 217b, 226, 304, or 319 may provide, to the processor 120, the sensing information about the position and angle of the electronic device 1100, 101, 200, or 300 and/or the direction in which the electronic device 1100, 101, 200, or 300 is facing.

For example, the processor 120 may selectively turn on at least one camera module (e.g., turn on camera operation) capable of receiving light well from the light (or light source) among the camera module 180, 216a, 216b, 225, 305, or 312, based on the sensing information about the position and angle of the electronic device 1100, 101, 200, or 300 and/or the direction in which the electronic device 1100, 101, 200, or 300 is facing. For example, the processor 120 may selectively turn off (e.g., turn off camera operation) one of the camera modules 180, 216a, 216b, 225, 305, 312 that is capable of photographing a subject of a particular color (e.g., human skin, an object colored a particular color (or a wall or floor surface)).

According to an embodiment, the processor 120, in case that the angle 1120 of the electronic device 1100, 101, 200, or 300 (e.g., an angle between the electronic device 1100, 101, 200, or 300 and a table surface) is greater than or equal to a preconfigured angle, may selectively turn on at least one camera module (e.g., turn on camera operation) disposed on the first surface (e.g., the surface on which a screen is displayed) of the electronic device 1100, 101, 200, or 300. For example, the processor 120, in case that the angle 1120 of the electronic device 1100, 101, 200, or 300 (e.g., an angle between the electronic device 1100, 101, 200, or 300 and a table surface) is greater than or equal to a preconfigured angle, may selectively turn off at least one camera module (e.g., turn off camera operation) disposed on the second surface (e.g., the surface on which no screen is displayed, or the surface opposite to the first surface) of the electronic device 1100, 101, 200, or 300. Accordingly, the electronic device 1100, 101, 200, or 300 may improve sensing accuracy of the color temperature value around thereof.

According to an embodiment, the processor 120, in case that the angle 1120 of the electronic device 1100, 101, 200, or 300 (e.g., an angle between the electronic device 1100, 101, 200, or 300 and a table surface) is less than a preconfigured angle, may selectively turn on at least one camera module (e.g., turn on camera operation) disposed on the second surface (e.g., the surface on which no screen is displayed, or the surface opposite to the first surface) of the electronic device 1100, 101, 200, or 300. For example, the processor 120, in case that the angle 1120 of the electronic device 1100, 101, 200, or 300 (e.g., an angle between the electronic device 1100, 101, 200, or 300 and a table surface) is less than a preconfigured angle, may selectively turn off at least one camera module (e.g., turn off camera operation) disposed on the first surface (e.g., the surface on which a screen is displayed) of the electronic device 1100, 101, 200, or 300. Accordingly, the electronic device 1100, 101, 200, or 300 may improve sensing accuracy of the color temperature value around thereof.

According to an embodiment, the processor 120, regardless of the relationship between the angle 1120 of the electronic device 1100, 101, 200, or 300 (e.g., an angle between the electronic device 1100, 101, 200, or 300 and a table surface) and the preconfigured angle, may turn on all (e.g., the entire) camera modules 180, 216a, 216b, 225, 305, and 312 (e.g., turn on camera operation) disposed in the electronic device 1100, 101, 200, or 300. The processor 120 may determine the color temperature value around the electronic device 1100, 101, 200, or 300, based on a highest color temperature value among color temperature values obtained from all (e.g., the entire) camera modules 180, 216a, 216b, 225, 305, and 312.

According to an embodiment, the processor 120 may obtain the color temperature value around the electronic device 1100, 101, 200, or 300 from the camera module 180, 216a, 216b, 225, 305, or 312. The processor 120 may change (e.g., adjust or control) the color temperature of the display 1110 (e.g., the display module 160 in FIG. 1, the first display 230 in FIG. 2A, the second display 235 in FIG. 2B, the display 301 in FIG. 3A, or the display 410 in FIGS. 4A and 4B), based on the color temperature value around the electronic device 1100, 101, 200, or 300. For example, the processor 120 may control an operation of the DDIC (e.g., the DDIC 430 in FIGS. 4A and 4B) to change the color temperature of the display 1110, 160, 230, 235, 301, or 410. The DDIC 430 may change (e.g., adjust or control) the color temperature of the display 1110, 160, 230, 235, 301, or 410 based on the control of the processor 120.

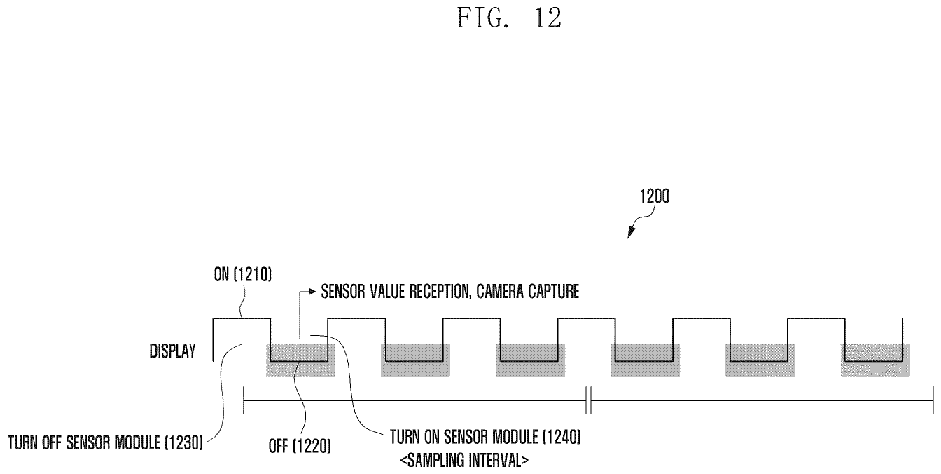

FIG. 12 is a view 1200 illustrating a method for sampling of a sensor value and a color temperature value according to an embodiment of the disclosure.

Referring to FIGS. 11 and 12, according to an embodiment, a processor (e.g., the processor 120 in FIG. 1) of an electronic device 1100 (e.g., the electronic device 101 in FIG. 1, the electronic device 200 in FIGS. 2A and 2B, or the electronic device 300 in FIGS. 3A and 3B) may selectively turn on (e.g., turn on sensor operation) or turn off (e.g., turn off sensor operation) operations of a sensor module (e.g., the sensor module 176 in FIG. 1, the sensor modules 217a, 217b, and 226 in FIGS. 2A and 2B, or the sensor modules 304 and 319 in FIGS. 3A and 3B) to sense a color temperature around the electronic device 1100, 101, 200, or 300.

For example, during a time 1210 when a display (e.g., the display module 160 in FIG. 1, the display 230 or 235 in FIGS. 2A and 2B, the display 301 in FIG. 3A, or the display 410 in FIGS. 4A and 4B) is turned on, the processor 120 may selectively turn off 1230 the operation of the sensor module 176, 217a, 217b, 226, 304 or 319 (e.g., turn off sensor operation).

For example, during a time 1220 when the display 160, 230, 235, 301, or 410 is turned off, the processor 120 may selectively turn on 1240 the operation of the sensor module 176, 217A, 217B, 226, 304, or 319 (e.g., turn on sensor operation).

According to an embodiment, the processor (e.g., the processor 120 in FIG. 1) of the electronic device 1100 (e.g., the electronic device 101 in FIG. 1, the electronic device 200 in FIGS. 2A and 2B, or the electronic device 300 in FIGS. 3A and 3B) may selectively turn on 1240 (e.g., turn on camera operation) or turn off (e.g., turn off camera operation) operations of a camera module (e.g., the camera module 180 in FIG. 1, the camera module 216a, 216b, or 225 in FIGS. 2A and 2B, or the camera module 305 or 312 in FIGS. 3A and 3B) to sense the color temperature around the electronic device 1100, 101, 200, or 300.

For example, during a time 1210 when the display 160, 230, 235, 301, or 410 is turned on, the processor 120 may selectively turn off 1230 the operation of the camera module 180, 216a, 216b, 225, 305, or 312 (e.g., turn off camera operation).

For example, during a time 1220 when the display 160, 230, 235, 301, or 410 is turned off, the processor 120 may selectively turn on 1240 the operation of the camera module 180, 216a, 216b, 225, 305, or 312 (e.g., turn on camera operation).

According to an embodiment, the processor 120 may selectively turn on 1240 multiple camera modules 180, 216a, 216b, 225, 305, and 312 (e.g., turn on camera operation). The processor 120 may configure the multiple camera modules 180, 216a, 216b, 225, 305, and 312 to have different sampling rates and/or sampling intervals.

For example, in case that the angle of the electronic device 1100, 101, 200, 300 is configured in a first direction (e.g., a surface on which a screen is displayed is positioned to face a light, a first surface (front face) of the electronic device is positioned to face the light), the processor 120 may control the camera module disposed on the first surface (e.g., the side on which a screen is displayed) of the electronic device 1100, 101, 200, 300 to operate at a first sampling rate and/or a first sampling interval. For example, in case that the angle of the electronic device 1100, 101, 200, 300 is configured in a second direction (e.g., a surface on which no screen is displayed is positioned to face a light, a second surface (rear face) of the electronic device is positioned to face the light), the processor 120 may control the camera module disposed on the second surface (e.g., the side on which no screen is displayed or the surface opposite to the first surface) of the electronic device 1100, 101, 200, 300 to operate at a second sampling rate and/or a second sampling interval. For example, the first sampling rate may be greater than the second sampling rate. The first sampling interval may be less than the second sampling interval.

According to an embodiment, the color temperature value of the light (or light source) may have a continuous value. It may be difficult to continuously change (e.g., adjust or control) the color temperature of the displays 160, 230, 235, 301, or 410 due to the need to tune the color temperature of the displays 160, 230, 235, 301, or 410 based on the color temperature values around the electronic device 1100, 101, 200, or 300. Changing (e.g., adjusting or controlling) the color temperature of the display 160, 230, 235, 301 or 410 may be performed in a discontinuous manner by dividing the color temperature values of the light (e.g., the light source) into ranges and mapping the ranges to respective tuning values.

For example, there may be values (e.g., the color temperature values of 2500K, 3000K, 4000K, 5000K, 6000K, 7000K, and 8000K shown in FIG. 7) that serve as boundaries to divide ranges of color temperature values of the light (e.g., the light source). The color temperature around the electronic device 1100, 101, 200, or 300 may be incorrectly perceived as having changed when in fact the color temperature around the electronic device 1100, 101, 200, or 300 has not changed, but the light (e.g., the light source) emits light of a value that is a boundary for dividing a range of color temperature values. In case that the color temperature around is recognized to have changed due to hysteresis, even though the color temperature around the electronic device 1100, 101, 200, or 300 has not changed, the color temperature of the display 160, 230, 235, 301 or 410 may be changed (e.g., adjusted or controlled) from time to time. Frequent color temperature changes (e.g., adjustments, controls) of the displays 160, 230, 235, 301, or 410 may consume unnecessary power, and frequent color temperature changes of the displays 160, 230, 235, 301, or 410 may cause discomfort to the user.

According to an embodiment, the electronic device 1100, 101, 200, or 300 according to an embodiment of the disclosure may prevent the color temperature around the electronic device 1100, 101, 200, or 300 from being incorrectly perceived to have changed when in fact the color temperature around thereof has not changed, and may prevent the color temperature of the display 160, 230, 235, 301, or 410 from being frequently changed (e.g., adjusted or controlled).

For example, the processor 120 may accumulatively sample sensing data from the sensor modules 176, 217a, 217b, 226, 304, or 319 at predetermined intervals. The processor 120 may store the accumulatively sampled sensing data in the memory (e.g., the memory 130 in FIG. 1).

For example, in case that current input sensing data deviates from a preconfigured range value relative to the accumulatively sampled sensing data (e.g., the current input sensing data exceeds a preconfigured value relative to the accumulatively sampled sensing data (e.g., a first value), or the current input sensing data is less than a preconfigured value relative to the accumulatively sampled sensing data (e.g., a second value), the processor 120 may not reflect the current input sensing data and may exclude the current input sensing data without reflecting the current input sensing data to the accumulated sampling data (e.g., accumulated sampling data average value). Here, the color temperature of the display may remain the same, or may be changed depending on other conditions.

For example, the processor 120 may determine the preconfigured value based on the accumulatively sampled sensing data, a reference for exceeding or falling below the preconfigured value may be determined based on a size of the sensing data relative to the accumulatively sampled sensing data.

For example, the determination of the color temperature change of the display 160, 230, 235, 301, or 410 may be performed based on the accumulatively sampled sensing data, the preconfigured value, and the current input sensing data. In case that an average value of the accumulatively sampled sensing data is 3000K, the preconfigured value is 100K, and the current input sensing data is 2000K, when reflecting the preconfigured value (e.g., a first value or a second value)+100K to the average value of the accumulatively sampled sensing data of 3000K, the range value for determining the color temperature change may be from 2900K to 3100K. Here, various methods (e.g., a time averaging method, a bin averaging method, or an averaging method at a fixed number of times) may be employed to calculate the average value of the accumulatively sampled sensing data (e.g., 3000K). In case that the current input sensing data is 2000K, the value is less than 2900K to 3100K, which is the range value for determining color temperature change, so the current input sensing data may not be reflected. Here, the current input sensing data may be excluded without being reflected in the accumulated sampling data (e.g., the average value of the accumulated sampling data).

For example, in case that an average value of the accumulatively sampled sensing data is 3000K, the preconfigured value is 100K, and the current input sensing data is 4000K, when reflecting the preconfigured value+100K to the average value of the accumulatively sampled sensing data of 3000K, the range value for determining the color temperature change may be from 2900K to 3100K. Here, various methods (e.g., a time averaging method, a bin averaging method, or an averaging method at a fixed number of times) may be employed to calculate the average value of the accumulatively sampled sensing data (e.g., 3000K). In case that the current input sensing data is 4000K, the value exceeds 2900K to 3100K, which is the range value for determining color temperature change, so the current input sensing data may not be reflected. Here, the current input sensing data may be excluded without being reflected in the accumulated sampling data (e.g., the average value of the accumulated sampling data).

For example, in case that an average value of the accumulatively sampled sensing data is 3000K, the preconfigured value is 100K, and the current input sensing data is 2900K, when reflecting the preconfigured value=100K to the average value of the accumulatively sampled sensing data of 3000K, the range value for determining the color temperature change may be from 2900K to 3100K. Here, various methods (e.g., a time averaging method, a bin averaging method, or an averaging method at a fixed number of times) may be employed to calculate the average value of the accumulatively sampled sensing data (e.g., 3000K). In case that the current input sensing data is 2900K, the value does not deviate from 2900K to 3100K, which is the range value for determining color temperature change, so the current input sensing data may be reflected. Here, the current input sensing data may be reflected in the accumulated sampling data (e.g., the average value of the accumulated sampling data).

As such, the current input sensing data may be reflected in the accumulated sampled sensing data (e.g., adding the current input sensing data to the accumulated sampled sensing data) so as to be reflected in calculating the color temperature.

Accordingly, by excluding the current input sensing data value that exceeds or is less than the accumulatively sampled sensing data value when sensing data, it is possible to prevent incorrect color temperature changes due to sensing errors.

For example, the processor 120 may accumulatively sample raw data of the color temperature value from the sensor modules 180, 216a, 216b, 225, 305, or 312 at predetermined intervals. The processor 120 may store raw data of accumulatively sampled color temperature values in the memory (e.g., the memory 130 in FIG. 1). For example, in case that the current input color temperature value exceeds a preconfigured range value relative to the raw data of the accumulatively sampled color temperature value, (e.g., the current input color temperature value exceeds a preconfigured value (e.g., a first value) relative to the raw data of the accumulatively sampled color temperature values, or the current input color temperature value is less than a preconfigured value (e.g., a second value) relative to the raw data of accumulatively sampled color temperature values), the processor 120 may not reflect the current input color temperature value and maintain the current state (e.g., not change the color temperature of the display and maintain the previous color temperature).

For example, the processor 120, in case that the current input color temperature value exceeds or is less than the preconfigured range value relative to the average value of the cumulatively sampled color temperatures (e.g., the average value of the raw data), may not reflect the current input color temperature. Here, the current input color temperature value may be excluded without being reflected in the average value of the accumulatively sampled color temperatures. In this case, various methods (e.g., a time averaging method, a bin averaging method, or an averaging method at a fixed number of times) may be employed to calculate the average value of the accumulatively sampled color temperatures.

For example, the determination of the color temperature change of the display 160, 230, 235, 301, 410, or 1110 may be performed based on the accumulatively sampled color temperature average value (e.g., the average value of the raw data), the preconfigured value, and the current input color temperature value. In case that the accumulatively sampled color temperature average value (e.g., the average value of the raw data) is 3000K, the preconfigured value is 100K, and the current input color temperature value is 2000K, when reflecting the preconfigured value=100K to the accumulatively sampled color temperature average value of 3000K, the range value for determining the color temperature change may be from 2900K to 3100K. In case that the current input color temperature value is 2000K, the value is less than 2900K to 3100K, which is the range value for determining color temperature change, so the current input color temperature value may be excluded without being reflected in the accumulatively sampled color temperature average value. In this case, various methods (e.g., a time averaging method, a bin averaging method, or an averaging method at a fixed number of times) may be employed to calculate the average value of the accumulatively sampled color temperatures.

For example, in case that the accumulatively sampled color temperature average value (e.g., the average value of the raw data) is 3000K, the preconfigured value is 100K, and the current input color temperature value is 4000K, when reflecting the preconfigured value+100K to the accumulatively sampled color temperature average value of 3000K, the range value for determining the color temperature change may be from 2900K to 3100K. In case that the current input color temperature value is 4000K, the value exceeds 2900K to 3100K, which is the range value for determining color temperature change, so the current input color temperature value may be excluded without being reflected in the accumulatively sampled color temperature average value. In this case, various methods (e.g., a time averaging method, a bin averaging method, or an averaging method at a fixed number of times) may be employed to calculate the average value of the accumulatively sampled color temperatures.

For example, in case that the accumulatively sampled color temperature average value (e.g., the average value of the raw data) is 3000K, the preconfigured value is 100K, and the current input color temperature value is 4000K, when reflecting the preconfigured value+100K to the accumulatively sampled color temperature average value of 3000K, the range value for determining the color temperature change may be from 2900K to 3100K. In case that the current input color temperature value is 2900K, the value does not deviate from 2900K to 3100K, which is the range value for determining color temperature change, so the current input color temperature value may be reflected. The current input color temperature value may be reflected in the accumulatively sampled color temperature average value.

As such, the current input color temperature value may be reflected in the accumulatively sampled color temperature average value (e.g., adding the current input color temperature value to the accumulatively sampled color temperature average value) so as to be used for changing the color temperature.

Accordingly, by excluding the current input color temperature value that exceeds or is less than the accumulatively sampled color temperature average value when sensing the color temperature, it is possible to prevent incorrect color temperature changes due to sensing errors.

According to an embodiment, the processor 120 may change the sampling rate for obtaining sensing data by using the sensor module 176, 217a, 217b, 226, 304, and 319.

For example, the processor 120 may change the interval at which the sensing data from the sensor modules 176, 217a, 217b, 226, 304, or 319 is accumulatively sampled. For example, in case that there is no change in sensing data from the sensor modules 176, 217a, 217b, 226, 304, or 319 for predetermined times period (e.g., the change in sensing data is less than or equal to a preconfigured value), the sampling rate at which sensing data is obtained may be reduced and/or the interval at which sensing data is accumulatively sampled may be increased. The sampling rate and the sampling interval may be changed by performing a signal process procedure on the sensing data using a low-pass filter and/or a high-pass filter.

According to an embodiment, the processor 120 may change the sampling rate for obtaining raw data of the color temperature value by using the camera module 180, 216a, 216b, 225, 305, or 312.

According to an embodiment, the processor 120 may change the sampling interval at which raw data of the color temperature value from the camera module 180, 216a, 216b, 225, 305, or 312 is accumulatively sampled. For example, in case that there is no change in the raw data of the color temperature value of the camera module 180, 216a, 216b, 225, 305, or 312 (e.g., in case that the change in the raw data of the color temperature value is less than or equal to a preconfigured value), the sampling rate at which the raw data of the color temperature value is obtained may be reduced and/or the sampling interval at which the raw data of the color temperature value is accumulatively sampled may be increased. The sampling rate and the sampling interval may be changed by performing a signal process procedure on the raw data of the color temperature value using a low-pass filter and/or a high-pass filter.

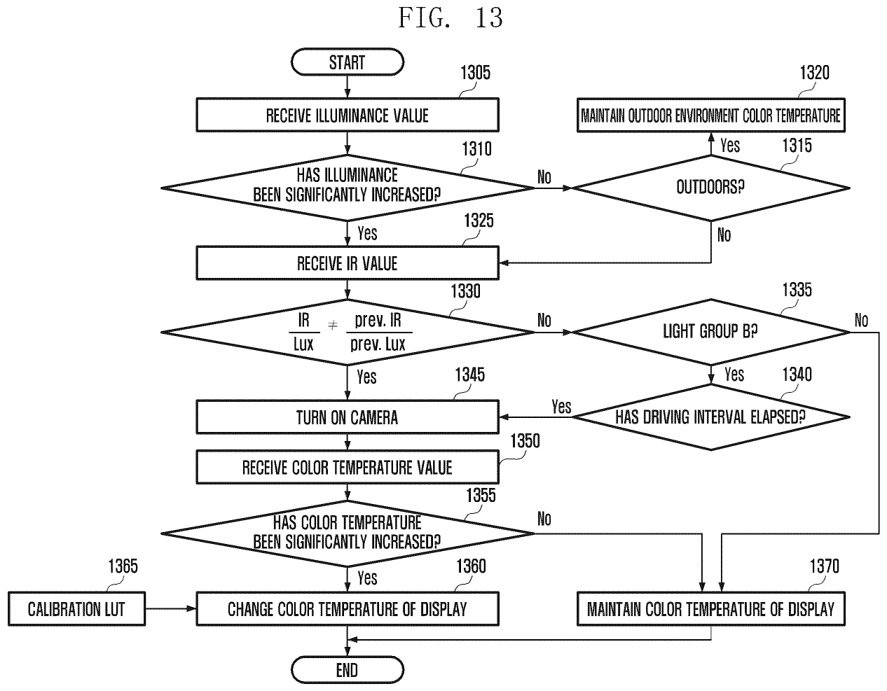

FIG. 13 is a flowchart illustrating an operating method of an electronic device according to an embodiment of the disclosure.

Referring to FIG. 13, an electronic device (e.g., the electronic device 101 in FIG. 1, the electronic device 200 in FIGS. 2A and 2B, the electronic device 300 in FIGS. 3A and 3B, or the electronic device 1100 in FIG. 11) according to an embodiment of the disclosure may include a processor (e.g., the processor 120 in FIG. 1), memory (e.g., the memory 130 in FIG. 1), a display module (e.g., the display module 160 in FIG. 1 or the display module 160 in FIGS. 4A and 4B), a sensor module (e.g., the sensor module 176 in FIG. 1, the sensor modules 217a, 217b, and 226 in FIGS. 2A and 2B, or the sensor modules 304 and 319 in FIGS. 3A and 3B), and a camera module (e.g., the camera module 180 in FIG. 1, the camera module 216a, 216b, or 225 in FIGS. 2A and 2B, or the camera module 305 or 312 in FIGS. 3A and 3B). For example, the sensor module 176, 217a, 217b, 226, 304, or 319 may include a gesture sensor, a grip sensor, a color sensor, an infrared (IR) sensor, a luminance sensor, a magnetic sensor (e.g., a 6-axis sensor, or a geomagnetic sensor), an acceleration sensor, an ultrasonic sensor, an iris recognition sensor, or a distance detection sensor (e.g., a time of flight (TOF) sensor, a light detection and ranging (LiDAR) sensor) and/or a control circuit for the sensors.

According to an embodiment, the electronic device 101, 200, 300, or 1100 according to an embodiment of the disclosure may increase a sampling rate of the sensor module 176, 217a, 217b, 226, 304, or 319 and shorten a sampling interval in a low illuminance environment having an illuminance value equal to or less than a preconfigured illuminate value. Accordingly, the electronic device 101, 200, 300, or 1100 may improve sensing accuracy of the illuminance value and the IR value around thereof.

According to an embodiment, the electronic device 101, 200, 300, or 1100 according to an embodiment of the disclosure may reduce a sampling rate of the sensor module 176, 217a, 217b, 226, 304, or 319 and increase a sampling interval in a high illuminance environment having an illuminance value equal to or greater than a preconfigured illuminate value. Accordingly, the electronic device 101, 200, 300, or 1100 may reduce unnecessary power consumption.

According to an embodiment, the electronic device 101, 200, 300, or 1100 according to an embodiment of the disclosure may increase a sampling rate of the camera module 180, 216a, 216b, 225, 305, or 312 and shorten a sampling interval in a low illuminance environment having an illuminance value equal to or less than a preconfigured illuminate value. Accordingly, the electronic device 101, 200, 300, or 1100 may improve sensing performance for the color temperature value around thereof.

According to an embodiment, the electronic device 101, 200, 300, or 1100 according to an embodiment of the disclosure may reduce a sampling rate of the camera module 180, 216a, 216b, 225, 305, or 312 and increase a sampling interval in a high illuminance environment having an illuminance value equal to or greater than a preconfigured illuminate value. Accordingly, the electronic device 101, 200, 300, or 1100 may reduce unnecessary power consumption.

According to an embodiment, the electronic device 101, 200, 300, or 1100 according to an embodiment of the disclosure may turn off an operation of the sensor module 176, 217a, 217b, 226, 304, or 319 and shorten a sampling interval in a low illuminance environment having an illuminance value equal to or less than a preconfigured illuminate value. Considering the user's color recognition, the processor 120 may turn off the operation of the sensor modules 176, 217a, 217b, 226, 304 or 319 in low illuminance environments, since changes in the color temperature around the electronic devices 101, 200, 300, or 1100 may be meaningless. The processor 120 may turn off a color temperature changing function of the display (e.g., the display module 160 in FIG. 1, the display 230 or 235 in FIGS. 2A and 2B, the display 301 in FIG. 3A, or the display 410 in FIGS. 4A and 4B) in low illuminance environments.

According to an embodiment, the electronic device 101, 200, 300, or 1100 according to an embodiment of the disclosure may turn of an operation of the camera module 180, 216a, 216b, 225, 305, or 312 and shorten a sampling interval in a low illuminance environment having an illuminance value equal to or less than a preconfigured illuminate value. Considering the user's color recognition, the processor 120 may turn off the operation of the camera modules 180, 216a, 216b, 225, 305 or 312 in low illuminance environments, since changes in the color temperature around the electronic devices 101, 200, 300, or 1100 may be meaningless. The processor 120 may turn off a color temperature changing function of the display (e.g., the display module 160 in FIG. 1, the display 230 or 235 in FIGS. 2A and 2B, the display 301 in FIG. 3A, or the display 410 in FIGS. 4A and 4B) in low illuminance environments.

In operation 1305, the processor 120 may operate the sensor module 176, 217a, 217b, 226, 304, or 319 (e.g., turn on the sensor module) and sense the illuminance around the electronic device 101, 200, 300, or 1100. The processor 120 may obtain information about the illuminance around the electronic device 101, 200, 300, or 1100 from the sensor module 176, 217a, 217b, 226, 304, or 319. The information about the illuminance around the electronic device 101, 200, 300, or 1100 may include the illuminance value and the IR value.

Prior to describing the specifics of the operating method of the electronic device 101, 200, 300, or 1100, it is exemplified that an initial color temperature of the displays 160, 230, 235, 301, 410 is configured for an outdoor environment.

In operation 1310, the processor 120 may determine, based on the information about the illuminance around the electronic device 101, 200, 300, or 1100, whether the illuminance around the electronic device 101, 200, 300, or 1100 exceeds (e.g., increases significantly) a preconfigured illuminance.

In case of determining that the illuminance around the electronic device 101, 200, 300, or 1100 exceeds (e.g., increases significantly) the preconfigured illuminance from a result of the determination in operation 1310 (Yes), the processor 120 may perform operation 1325.

In case of determining that the illuminance around the electronic device 101, 200, 300, or 1100 does not exceed (e.g., increase significantly) the preconfigured illuminance from a result of the determination in operation 1301 (No), the processor 120 may perform operation 1315.

In operation 1315, the processor 120 may identify the illuminance value and the IR value included in the information about the illuminance around the electronic device 101, 200, 300, or 1100 and determine the type of the light (e.g., light source) at a position at which the electronic device 101, 200, 300, or 1100 is located. Different lights (or light sources) may have different IR values at a specific illuminance. Considering that different lights (or light sources) have different IR values at a specific illuminance, the processor 120 may match the IR value with the illuminance value. The processor 120 may determine the types of the lights (or light sources) based on the IR value at a specific illuminance. The processor 120 may determine that the electronic device 101, 200, 300, or 1100 is currently exposed to daylight (e.g., sunlight) so that a current light (or light source) is outdoor light (e.g., daylight or sunlight).

In case of determining that the current light (or light source) is outdoor light (e.g., daylight or sunlight) (Yes) from a result of the determination in operation 1315 and the electronic device 101, 200, 300, or 1100 is located in an outdoor environment, operation 1320 may be performed.

In operation 1320, the processor 120 may maintain the color temperature of the display 160, 230, 235, 301, or 410 configured to be suitable for the outdoor environment without changing same.

In case of determining that the current light (or light source) is not outdoor light (e.g., daylight or sunlight) (No) from a result of the determination in operation 1315, operation 1325 may be performed.

In operation 1325, the processor 120 may operate the sensor module 176, 217a, 217b, 226, 304, or 319 (e.g., turn on the sensor module) and sense an IR strength around the electronic device 101, 200, 300, or 1100. The processor 120 may obtain information about the IR strength around the electronic device 101, 200, 300, or 1100 from the sensor module 176, 217a, 217b, 226, 304, or 319.

For example, the processor 120 may concurrently perform operation 1305 and operation 1325. For example, the processor 120 may consecutively perform operation 1305 and operation 1325. For example, the processor 120 may perform operation 1305 and operation 1325 in parallel.

In operation 1330, the processor 120 may identify a ratio of an illuminance value and an IR strength value based on the information about the illuminance and the information about the IR strength around the electronic device 101, 200, 300, or 1100. Thereafter, the processor 120 may determine whether the color temperature of the display 160, 230, 235, or 410 has been changed.

According to an embodiment, the processor 120 may sense the illuminance value (e.g., the previous illuminance value (prev. Lux)) and the IR value (e.g., the previous IR value (prev. IR)) of the light (or light source) around the electronic device 101, 200, 300, or 1100 at a first time point. The processor 120 may sense the illuminance value (e.g., the current illuminance value (Lux)) and the IR value (e.g., the current IR value (IR)) of the light (or light source) around the electronic device 101, 200, 300, or 1100 at a second time point.

The illuminance value of the light (or light source) may be configured as a control variable and the color temperature value may be configured as an independent variable. When data is collected by configuring the illuminance value of the light (or light source) as the control variable and the color temperature value as the independent variable, IR values may vary depending on the color temperature value. Through this, at an identical illumination value, the color temperature value may be roughly inferred from the IR value.

According to an embodiment, the processor (e.g., the processor 120 of FIG. 1) may determine whether the condition of Equation 1 is satisfied (e.g., a ratio of a current illuminance value to an IR value is different from a ratio of a previous illuminance value to an IR value). The processor 120 may determine whether the color temperature around the electronic device 101, 200, 300, or 1100 has been changed, based on whether the condition of Equation 1 is satisfied (e.g., the ratio of the current illuminance value to the IR value is different from the ratio of the previous illuminance value to the IR value).

According to an embodiment, the processor 120 may determine whether the condition of Equation 1 is satisfied (e.g., the ratio of the current illuminance value to the IR value is different from the ratio of the previous illuminance value to the IR value).

For example, in case that the ratio of the current illuminance value to the IR value is different from the ratio of the previous illuminance value to the IR value (Yes), the processor 120 may determine that the color temperature (e.g., the color temperature value) around the electronic device 101, 200, 300, or 1100 has been changed. In this case, operation 1345 may be performed.

For example, in case that the ratio of the current illuminance value to the IR value is identical to the ratio of the previous illuminance value to the IR value (No), the processor 120 may determine that the color temperature (e.g., the color temperature value) around the electronic device 101, 200, 300, 1100 has not been changed. In this case, operation 1335 may be performed.

In operation 1335, the processor 120 may determine the type of the light (or light source), based on the IR value sensed by the IR sensor and the illuminance value sensed by the illuminance sensor disposed in the sensor module 176, 217a, 217b, 226, 304, or 319.

The power of the IR wavelength (e.g., 630 nm) component may vary depending on the type of the light (or light source). For example, the spectral power distribution (e.g., 910 in FIG. 9) of a fluorescent lamp (e.g., the fluorescent lamp 830 in FIG. 8C), the spectral power distribution (e.g., 920 in FIG. 9) of a halogen lamp (e.g., the halogen lamp 840 in FIG. 8D), the spectral power distribution (e.g., 930 in FIG. 9) of an incandescent lamp (e.g., the incandescent lamp 820 FIG. 8B), and the spectral power distribution (e.g., 940 in FIG. 9) of a sunlight (e.g., the sunlight 810 in FIG. 8A) may be different from each other. The fluorescent lamp 830 may have almost no IR value across the entire wavelength band (e.g., substantially no IR value). Different lights (or light sources) may have different IR values at a specific illuminance. Considering that different lights (or light sources) have different IR values at a specific illuminance, the processor 120 may match the IR value with the illuminance value. The processor 120 may determine the types of the lights (or light sources) based on the IR value at a specific illuminance. The processor 120 may match the IR values with the illuminance values of the lights (or light sources) and analyze the illuminance values and the IR values to classify the lights (or light sources).

According to an embodiment, the processor 120 may classify, based on the size of the IR value relative to the illuminance value of the lights (or light sources), lights (or light sources) of which the size of the IR value changes relative to the illuminance value into a first light group (e.g., the first light group 1010 in FIG. 10) (e.g., light group A). For example, the processor 120 may classify, based on the magnitude of the IR value relative to the illuminance value of the lights (or light sources), the incandescent lamp (e.g., the incandescent lamp 820 in FIG. 8B), the halogen lamp (e.g., the halogen lamp 840 in FIG. 8D), and the LED lamp (e.g., the cool white light LED lamp 850 in FIG. 8E, the warm white light LED lamp 860 in FIG. 8F) into the first light group 1010 (e.g., light group A).

According to an embodiment, the processor 120 may classify, based on the size of the IR value relative to the illuminance value of the lights (or light sources), lights (or light sources) of which the size of the IR value does not change relative to the illuminance value into a second light group (e.g., the second light group 1020 in FIG. 10) (e.g., light group B). For example, the processor 120 may classify, based on the size of the IR value relative to the illuminance value of the lights (or light sources), the florescent lamp (e.g., the fluorescent lamp 830 in FIG. 8C) into the second light group 1020 (e.g., light group B).

According to an embodiment, the processor 120 may determine the light (or light source) corresponds to the second light group 1020 (e.g., light group B).

For example, as a result of the determination in operation 1335, in case that the light (or light source) does not correspond to the second light group 1020 (e.g., light group B) (No), operation 1370 may be performed.

For example, as a result of the determination in operation 1335, in case that the light (or light source) corresponds to the second light group 1020 (e.g., light group B) (Yes), operation 1340 may be performed.

In operation 1340, the processor 120, in case that the light (or light source) corresponds to the second light group 1020 (e.g., light group B) (Yes), may determine whether a drive interval for measuring the color temperature around the electronic device 101, 200, 300, or 1100 has elapsed.

As a result of the determination in operation 1340, in case that the drive interval for measuring the color temperature around the electronic device 101, 200, 300, or 1100 has not elapsed (No), operation 1370 may be performed.

As a result of the determination in operation 1340, in case that the drive interval for measuring the color temperature around the electronic device 101, 200, 300, or 1100 has elapsed (Yes), operation 1345 may be performed.

In operation 1345, the processor 120 may selectively operate the camera module 180, 216a, 216b, 225, 305, or 312 (e.g., turn on camera operation).

For example, the camera module 180, 216a, 216b, 225, 305, or 312 may be operated by control of the processor 120 and obtain the color temperature value around the electronic device 101, 200, 300, or 1100. The camera module 180, 216a, 216b, 225, 305, or 312 may provide the color temperature value around the electronic device 101, 200, 300, or 1100 to the processor 120.

For example, the processor 120 may turn on operations of all (e.g., the entire) camera modules 180, 216a, 216b, 225, 305, and 312 disposed in the electronic device 101, 200, 300, or 1100 (e.g., turn on camera operation).

For example, the processor 120 may selectively turn on at least one of the camera modules 180, 216a, 216b, 225, and 305, and 312 disposed in the electronic device 101, 200, 300, or 1100 (e.g., turn on camera operation).

For example, the processor 120 may selectively turn on at least one camera module 180, 216a, or 305 disposed on a first surface (e.g., the front surface) of the electronic device 101, 200, 300, or 1100 among the camera modules 180, 216a, 216b, 225, 305, and 312 disposed in the electronic device 101, 200, 300, or 1100 (e.g., activate camera operation).

For example, the processor 120 may selectively turn on at least one camera module 180, 216b, 225, or 312 disposed on a second surface (e.g., the rear surface) of the electronic device 101, 200, 300, or 1100 among the camera modules 180, 216a, 216b, 225, 305, and 312 disposed in the electronic device 101, 200, 300, or 1100 (e.g., activate camera operation).

For example, the processor 120 may selectively turn on at least one camera module 180, 216a, or 305 disposed on the first surface (e.g., the front surface) and at least one camera module 180, 216b, 225, or 312 disposed on the second surface (e.g., the rear surface) of the electronic device 101, 200, 300, or 1100 among the camera modules 180, 216a, 216b, 225, 305, and 312 disposed in the electronic device 101, 200, 300, or 1100 (e.g., activate camera operation).

In operation 1350, the processor 120 may obtain the color temperature value around the electronic device 101, 200, 300, or 1100 from the camera module 180, 216a, 216b, 225, 305, or 312.

In operation 1355, the processor 120 may compare the previous color temperature value and the current color temperature value. For example, the processor 120 may determine whether the current color temperature value exceeds a preconfigured value (e.g., whether the color temperature value increases) relative to the previous color temperature value.

As a result of the determination in operation 1355, in case that the current color temperature value does not exceed a preconfigured value relative to the previous color temperature value (No), operation 1370 may be performed.

In operation 1370, in case that the current color temperature value does not exceed a preconfigured value relative to the previous color temperature value (No), the color temperature around the electronic device 101, 200, 300, or 1100, and thus the processor 120 may maintain the preconfigured color temperature of the display 160, 230, 235, 301, or 410.

As a result of the determination in operation 1355, in case that the current color temperature value exceeds a preconfigured value relative to the previous color temperature value (Yes), operation 1360 may be performed.

In operation 1360, the processor 120 may control, based on the color temperature value around the electronic device 101, 200, 300, or 1100, an operation of the DDIC (e.g., the DDIC 430 in FIGS. 4A and 4B) to change (e.g., adjust or control) the color temperature of the display 160, 230, 235, 301, or 410. For example, the processor 120, in case of determining that the color temperature value around the electronic device 101, 200, 300, of 1100 has been changed, may control an operation of the DDIC 430 to change (e.g., adjust or control) the color temperature of the display 160, 230, 235, 301, or 410.

In operation 1365, the memory (e.g., the memory 130 in FIG. 1) stores calibration data for changing (e.g., adjusting or controlling) the color temperature of the display 160, 230, 235, 301 or 410 in a lookup table (LUT). The processor 120 may obtain the calibration data from the lookup table to change (e.g., adjust or control) the color temperature of the display 160, 230, 235, 301 or 410. The processor 120 may provide, to the DDIC 430, the calibration data for changing (e.g., adjusting or controlling) the color temperature of the display 160, 230, 235, 301 or 410.

According to an embodiment, the DDIC 430 may change (e.g., adjust or control) the color temperature of the display 160, 230, 235, 301, or 410, based on the control of the processor 120 and the calibration data for changing (e.g., adjusting or controlling) the color temperature of the display 160, 230, 235, 301 or 410.

For example, the processor 120 may concurrently perform operation 1360 and operation 1365. For example, the processor 120 may consecutively perform operation 1360 and operation 1365. For example, the processor 120 may perform operation 1360 and operation 1365 in parallel.

For example, operations of the processor 120 may be performed by loading instructions stored in the memory 130.

According to an embodiment, the memory 130 may include main memory and storage (or auxiliary memory). The main memory may include volatile memory, such as dynamic random-access memory (DRAM), static RAM (SRAM), or synchronous dynamic RAM (SDRAM). The storage may include at least one of a one-time programmable ROM (OTPROM), a PROM, an EPROM, an EEPROM, a mask ROM, a flash ROM, flash memory, a hard drive, or a solid state drive (SSD).

According to an embodiment, the memory 130 may correspond to a non-volatile memory and include a large capacity storage. For example, the memory 130 may include at least one of a one-time programmable ROM (OTPROM), a PROM, an EPROM, an EEPROM, a mask ROM, a flash ROM, flash memory, a hard drive, or a solid state drive (SSD). The memory 130 may store various types of file data and the stored file data may be updated according to an operation of the processor 120.

For example, the memory 130 may include instructions for performing an operation of the processor 120. In addition, the memory 130 may include instructions for performing operations of the display module 160, the sensor module 176, 217a, 217b, 226, 304, or 319, the camera module 180, 216a, 216b, 225, 305, or 312, and the communication module (e.g., the communication module 190 in FIG. 1).

For example, a portion of operations 1305 to 1370 described in FIG. 13 may be omitted. Before or after the at least a portion of the operations illustrated in FIG. 13 may be added and/or inserted at least a portion of the operations described herein with reference to other drawings.

For example, the memory 130 may store instructions to cause the processor 120 to perform operations 1305 to 1370 described in FIG. 13.

An electronic device (e.g., the electronic device 101 in FIG. 1, the electronic device 200 in FIGS. 2A and 2B, the electronic device 300 in FIGS. 3A and 3B, or the electronic device 1100 in FIG. 11) according to an embodiment of the disclosure may include a display (e.g., the display 230 or 235 in FIGS. 2A and 2B, the display 301 in FIGS. 3A and 3B, or the display 410 in FIGS. 4A and 4B), a display driver (e.g., the DDIC 430 in FIGS. 4A and 4B) configured to drive the display 230, 235, 301, or 410, multiple sensor modules (e.g., the sensor module 176 in FIG. 1, the sensor modules 217a, 217b, and 226 in FIGS. 2A and 2B, or the sensor modules 304 and 319 in FIGS. 3A and 3B) configured to sense an illuminance value and an infrared ray (IR) value, and multiple camera modules (e.g., the camera module 180 in FIG. 1, the camera module 216a, 216b, or 225 in FIGS. 2A and 2B, or the camera module 305 or 312 in FIGS. 3A and 3B) configured to sense a color temperature. According to an embodiment, the electronic device 101, 200, 300, or 1100 may include a processor (e.g., the processor 120 in FIG. 1) configured to control operations of the display driver 430, the multiple sensor modules 176, 217a, 217b, 226, 304, and 319, and the multiple camera modules 180, 216a, 216b, 225, 305, and 312, and memory (e.g., the memory 130 in FIG. 1) operatively connected to the processor 120. The processor 120, when executed, may operate at least one of the multiple sensor modules 176, 217a, 217b, 226, 304, and 319 and obtain an illuminance value around the electronic device 101, 200, 300, or 1100. The processor 120, when executed, may operate at least one of the multiple sensor modules 176, 217a, 217b, 226, 304, and 319 and obtain an IR value around the electronic device 101, 200, 300, or 1100. The processor 120, when executed, may determine, based on the illuminance value and IR value around the electronic device 101, 200, 300, or 1100, whether a color temperature around the electronic device 101, 200, 300, or 1100 has been changed. The processor 120, when executed, in case of determining that the color temperature value around the electronic device 101, 200, 300, or 1100 has been changed, may operate at least one of the multiple camera modules 180, 216a, 216b, 225, 305, and 312 and obtain a color temperature value around the electronic device 101, 200, 300, or 1100. The processor 120, when executed, may control an operation of the display driver 430 to change the color temperature of the display 230, 235, 301, or 410, based on the color temperature value around the electronic device 101, 200, 300, or 1100.

According to an embodiment, the processor 120, when executed, may identify, when determining whether the color temperature around the electronic device 101, 200, 300, or 1100 has been changed, a first ratio of a first illuminance value and a first IR value around the electronic device 101, 200, 300, or 1100 obtained at a first time point. The processor 120, when executed, may identify a second ratio of a second illuminance value and a second IR value around the electronic device 101, 200, 300, or 1100 obtained at a second time point after the first time point. The processor 120, when executed, may determine whether the first ratio and the second ratio are different from each other.

According to an embodiment, the processor 120, when executed, in case that the first ratio and the second ratio are different from each other, may determine that the color temperature around the electronic device 101, 200, 300, or 1100 has been changed.

According to an embodiment, the processor 120, when executed, in case that the first ratio and the second ratio are not different from each other, may determine that the color temperature around the electronic device 101, 200, 300, or 1100 has not been changed.

According to an embodiment, the processor 120, when executed, may match the illuminance value and the IR value and determine a type of light around the electronic device 101, 200, 300, or 1100 based on an IR value matched to a specific illuminance value.

According to an embodiment, the processor 120, when executed, may classify, based on the size of the IR value relative to the illuminance value, a light of which the size of the IR value is changed relative to the illuminance value into a first light group. The processor 120, when executed, may drive, based on the classification of the first light group, at least one of the multiple camera modules 180, 216a, 216b, 225, 305, and 312.

According to an embodiment, the processor 120, when executed, may drive, based on the first light group, at least one of the multiple camera modules 180, 216a, 216b, 225, 305, and 312 at a time point when the color temperature around the electronic device 101, 200, 300, or 1100 is changed.

According to an embodiment, the processor 120, when executed, may classify, based on the size of the IR value relative to the illuminance value, a light of which the size of the IR value is not changed relative to the illuminance value into a second light group. The processor 120, when executed, may drive, based on the classification of the second light group, at least one of the multiple camera modules 180, 216a, 216b, 225, 305, and 312.

According to an embodiment, the processor 120, when executed, may drive, based on the second light group, at least one of the multiple camera modules 180, 216a, 216b, 225, 305, and 312 at predetermined times or at predetermined intervals.

According to an embodiment, the processor 120, when executed, may operate at least one of the multiple sensor modules 176, 217a, 217b, 226, 304, and 319 and obtain angle information about an angle of the electronic device 101, 200, 300, or 1100 and/or direction information about a direction in which the electronic device 101, 200, 300, or 1100 is facing. A camera module to be operated among the multiple camera modules 180, 216a, 216b, 225, 305, and 312 may be determined based on the angle information and/or the direction information.

According to an embodiment, the processor 120, when executed, in case that the angle of the electronic device 101, 200, 300, or 1100 is greater than or equal to a preconfigured angle based on the angle information, may operate at least one camera module disposed on a first surface of the electronic device 101, 200, 300, or 1100.

According to an embodiment, the processor 120, when executed, in case that the angle of the electronic device 101, 200, 300, or 1100 is less than a preconfigured angle based on the angle information, may operate at least one camera module disposed on a second surface opposite to the first surface of the electronic device 101, 200, 300, or 1100.

According to an embodiment, the processor 120, when executed, may operate two or more camera modules among the multiple camera modules 180, 216a, 216b, 225, 305, and 312. The processor 120, when executed, may configure the two or more camera modules to have different sampling times.

According to an embodiment, the processor 120, when executed, may operate two or more camera modules among the multiple camera modules 180, 216a, 216b, 225, 305, and 312. The processor 120, when executed, may configure the two or more camera modules to have different sampling intervals.

According to an embodiment, the processor 120, when executed, may operate, based on the angle information, at least one camera module 180, 216a, 216b, 225, 305, or 312 disposed on the first surface of the electronic device 101, 200, 300, or 1100 and at least one camera module 180, 216a, 216b, 225, 305, or 312 disposed on the second surface opposite to the first surface. The processor 120 may configure at least one camera module 180, 216a, 216b, 225, 305, or 312 disposed on the first surface and at least one camera module 180, 216a, 216b, 225, 305, or 312 disposed on the second surface to have different sampling times. The processor 120 may configure at least one camera module 180, 216a, 216b, 225, 305, or 312 disposed on the first surface and at least one camera module 180, 216a, 216b, 225, 305, or 312 disposed on the second surface to have different sampling intervals.

An operating method of an electronic device 101, 200, 300, or 1100 may include operating at least one of multiple sensor modules 176, 217a, 217b, 226, 304, and 319 and obtaining an illuminance value around the electronic device 101, 200, 300, or 1100. The operating method of the electronic device 101, 200, 300, or 1100 may include operating at least one of multiple sensor modules 176, 217a, 217b, 226, 304, and 319 and obtaining an IR value around the electronic device 101, 200, 300, or 1100. The operating method of the electronic device 101, 200, 300, or 1100 may include determining, based on the illuminance value and the IR value around the electronic device 101, 200, 300, or 1100, whether a color temperature around the electronic device 101, 200, 300, or 1100 has been changed. The operating method of the electronic device 101, 200, 300, or 1100 may include, in case of determining that the color temperature value around the electronic device 101, 200, 300, or 1100 has been changed, operating at least one of the multiple camera modules 180, 216a, 216b, 225, 305, and 312 and obtaining a color temperature value around the electronic device 101, 200, 300, or 1100. The operating method of the electronic device 101, 200, 300, or 1100 may include changing a color temperature of the display 230, 235, 301, or 410, based on a color temperature value around the electronic device 101, 200, 300, or 1100.

According to an embodiment, when determining whether the color temperature around the electronic device 101, 200, 300, or 1100 has been changed, a first ratio of a first illuminance value and a first IR value around the electronic device 101, 200, 300, or 1100 obtained at a first time point may be identified. A second ratio of a second illuminance value and a second IR value around the electronic device 101, 200, 300, or 1100 obtained at a second time point after the first time point may be identified. Whether the first ratio and the second ratio are different from each other may be determined.

According to an embodiment, in case that the first ratio and the second ratio are different from each other, it may be determined that the color temperature around the electronic device 101, 200, 300, or 1100 has been changed.

According to an embodiment, in case that the first ratio and the second ratio are not different from each other, it may be determined that the color temperature around the electronic device 101, 200, 300, or 1100 has not been changed.

According to an embodiment, the illuminance value and the IR value may be matched and a type of light around the electronic device 101, 200, 300, or 1100 may be determined based on an IR value matched to a specific illuminance value. A light of which the size of the IR value is changed relative to the illuminance value may be classified into a first light group, based on the size of the IR value relative to the illuminance value. At least one of the multiple camera modules 180, 216a, 216b, 225, 305, and 312 may be driven based on the first light group, wherein at least one of the multiple camera modules 180, 216a, 216b, 225, 305, and 312 may be driven, based on the classification of the first light group, at a time point when the color temperature around the electronic device 101, 200, 300, or 1100 is changed.

According to an embodiment, the illuminance value and the IR value may be matched and a type of light around the electronic device 101, 200, 300, or 1100 may be determined based on an IR value matched to a specific illuminance value. A light of which the size of the IR value is not changed relative to the illuminance value may be classified into a second light group, based on the size of the IR value relative to the illuminance value. At least one of the multiple camera modules 180, 216a, 216b, 225, 305, and 312 may be driven based on the classification of the second light group, wherein at least one of the multiple camera modules 180, 216a, 216b, 225, 305, and 312 may be driven based on the second light group at predetermined times or at predetermined intervals.

The electronic device and the operating method therefor according to an embodiment of the disclosure may use a camera module to sense a color temperature around the electronic device and change (e.g., adjust or control) a color temperature of a display to match the color temperature around the electronic device, thereby providing a user with a comfortable and color-accurate screen.

According to an embodiment of the disclosure, the electronic device and the operating method therefor may sense (e.g., measure) a color temperature around the electronic device by using a camera module disposed in the electronic device and change (e.g., adjust or control) a color temperature of a display based on the color temperature around the electronic device so as to reduce power consumption due to the driving of the camera module.

According to an embodiment of the disclosure, the electronic device and the operating method therefor may increase a sampling rate of a sensor module and shorten a sampling interval in a low illuminance environment having an illuminance value equal to or less than a preconfigured illuminate value. As such, it is possible to improve the sensing performance of ambient illuminance values and IR values of the electronic device.

According to an embodiment of the disclosure, the electronic device and the operating method therefor may reduce a sampling rate of a sensor module and increase a sampling interval in a high illuminance environment in which an illuminance value around the electronic device is equal to or greater than a preconfigured illuminate value. As such, unnecessary power consumption of electronic devices may be reduced.

According to an embodiment of the disclosure, the electronic device and the operating method therefor may increase a sampling rate of a camera module and shorten a sampling interval in a low illuminance environment in which an illuminance value around the electronic device is equal to or less than a preconfigured illuminate value. As such, it is possible to improve the sensing performance of ambient color temperature values of the electronic device.

According to an embodiment of the disclosure, the electronic device and the operating method therefor may reduce a sampling rate of a camera module and increase a sampling interval in a high illuminance environment in which an illuminance value around the electronic device is equal to or greater than a preconfigured illuminate value. As such, unnecessary power consumption of electronic devices may be reduced.

According to an embodiment of the disclosure, the electronic device and the operating method therefor may prevent the color temperature around the electronic device from being incorrectly perceived as having changed even though the color temperature around has not actually changed, and may prevent frequent color temperature changes (e.g., adjustments, controls) of the display.

It will be obviously appreciated by a person skilled in the art that effects which may be achieved from the disclosure are not limited to the effects described above and other effects that are not described above will be clearly understood from the following detailed description.

According to an embodiment, the processor 120 (e.g., a processing circuit) may be implemented as one or more integrated circuit (IC) (or circuitry) chips and may execute various data processing. The processor 120 may include at least one electrical circuit and may distribute and process instructions (or programs or data) stored in the memory 130 individually or collectively. The processor 120 may include a processor assembly including one or more processing circuits. The processor 120 may include any operative processing circuit configured to control performance and operations of one or more components (e.g., the memory 130, the display module 160, the sensor module 176 (e.g., a sensor), the camera module 180 (e.g., an image sensor), and/or the communication module 190 (e.g., a communication circuit)) of the electronic device 101. For example, the processor 120 (e.g., an application processor (AP)) may be implemented as a system on chip (SoC) (e.g., a single chip or chipset). For example, the processor 120 may be implemented as multiple cores (or at least one core circuit), multiple chips, or multiple chipsets. For example, the processor 120 may include one or more processing circuits. For example, the processor 120 may include one or more processing circuits configured to individually and/or collectively perform various functions of the disclosure. By way of non-limiting example, at least a portion of the processor 120 may be included in a first chip of the electronic device 101 and at least another portion of the processor 120 may be included in a second chip of the electronic device 101 different from the first chip of the electronic device 101.

According to an embodiment, there are one or more processors 120. For example, the processor 120 may have a multi-core processor structure such as a dual core, quad core, hexa core, or octa core. The processor 120 may execute instructions stored in the memory 130 to control operations of the electronic device 101. For example, the processor 120 may correspond to multiple processors which may divide multiple operations to processors and collectively perform the operations.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a display driver configured to drive the display;
multiple sensor circuits configured to sense an illuminance value and an infrared ray (IR) value;
multiple camera circuits configured to sense a color temperature;
memory comprising one or more storage media, storing instructions; and
one or more processors communicatively coupled to the display driver, the multiple sensor circuits, the multiple camera circuits, and the memory,
wherein the instructions, when executed by the one or more processors individually or collectively, cause the electronic device to:
operate at least one of the multiple sensor circuits to obtain an illuminance value around the electronic device,
operate at least one of the multiple sensor circuits to obtain an IR value around the electronic device,
determine whether a color temperature around the electronic device is changed, based on the illuminance value and the IR value around the electronic device,
in case of determining that the color temperature around the electronic device is changed, drive at least one of the multiple camera circuits to obtain a color temperature value around the electronic device, and
control an operation of the display driver to change a color temperature of the display, based on the color temperature value around the electronic device.

2. The electronic device of claim 1, wherein the instructions, when executed by the one or more processors individually or collectively, cause the electronic device to:
in case of determining whether the color temperature around the electronic device is changed,
identify a first ratio between a first illuminance value and a first IR value around the electronic device, obtained at a first time point,
identify a second ratio between a second illuminance value and a second IR value around the electronic device, obtained at a second time point after the first time point, and
determine whether the first ratio and the second ratio are different from each other.

3. The electronic device of claim 2, wherein the instructions, when executed by the one or more processors individually or collectively, cause the electronic device to, in case that the first ratio and the second ratio are different from each other, determine that the color temperature around the electronic device is changed.

4. The electronic device of claim 2, wherein the instructions, when executed by the one or more processors individually or collectively, cause the electronic device to, in case that the first ratio and the second ratio are not different from each other, determine that the color temperature around the electronic device is not changed.

5. The electronic device of claim 1, wherein the instructions, when executed by the one or more processors individually or collectively, cause the electronic device to:
match the illuminance value and the IR value, and
determine a type of light around the electronic device, based on an IR value matched to a specific illuminance value.

6. The electronic device of claim 1, wherein the instructions, when executed by the one or more processors individually or collectively, cause the electronic device to:
based on a size of the IR value relative to the illuminance value, classify a light, of which the size of the IR value relative to the illuminance value is changed, as a first light group, and
based on the classification of the first light group, drive at least one of the multiple camera circuits.

7. The electronic device of claim 6, wherein the instructions, when executed by the one or more processors individually or collectively, cause the electronic device to, based on the first light group, drive at least one of the multiple camera circuits at a time point when the color temperature around the electronic device is changed.

8. The electronic device of claim 1, wherein the instructions, when executed by the one or more processors individually or collectively, cause the electronic device to:
based on a size of the IR value relative to the illuminance value, classify a light, of which the size of the IR value relative to the illuminance value is not changed, as a second light group, and
based on the classification of the second light group, drive at least one of the multiple camera circuits.

9. The electronic device of claim 8, wherein the instructions, when executed by the one or more processors individually or collectively, cause the electronic device to, based on the second light group, drive at least one of the multiple camera circuits at predetermined times or at predetermined periods.

10. The electronic device of claim 1, wherein the instructions, when executed by the one or more processors individually or collectively, cause the electronic device to:
operate at least one of the multiple sensor circuits to obtain angle information about an angle of the electronic device or direction information about a direction in which the electronic device is oriented, and
based on the angle information or the direction information, determine a camera circuit to be operated among the multiple camera circuits.

11. The electronic device of claim 10, wherein the instructions, when executed by the one or more processors individually or collectively, cause the electronic device to, in case that the angle of the electronic device is greater than or equal to a preconfigured angle, based on the angle information, operate at least one camera circuit disposed on a first surface of the electronic device.

12. The electronic device of claim 11, wherein the instructions, when executed by the one or more processors individually or collectively, cause the electronic device to, in case that the angle of the electronic device is less than a preconfigured angle, based on the angle information, operate at least one camera circuit disposed on a second surface opposite to the first surface of the electronic device.

13. The electronic device of claim 10, wherein the instructions, when executed by the one or more processors individually or collectively, cause the electronic device to:
based on the angle information, operate at least one camera circuit disposed on a first surface of the electronic device and at least one camera circuit disposed on a second surface opposite to the first surface, and
configure the at least one camera circuit disposed on the first surface and the at least one camera circuit disposed on the second surface to have different sampling times or configure the at least one camera circuit disposed on the first surface and the at least one camera circuit disposed on the second surface to have different sampling periods.

14. The electronic device of claim 1, wherein the instructions, when executed by the one or more processors individually or collectively, cause the electronic device to:
operate two or more camera circuits among the multiple camera circuits, and
configure the two or more camera circuits to have different sampling times.

15. The electronic device of claim 1, wherein the instructions, when executed by the one or more processors individually or collectively, cause the electronic device to:
operate two or more camera circuits among the multiple camera circuits, and
configure the two or more camera circuits to have different sampling periods.

16. A method performed by an electronic device, the method comprising:
operating, by the electronic device, at least one of multiple sensor circuits to obtain an illuminance value around the electronic device;
operating, by the electronic device, at least one of the multiple sensor circuits to obtain an infrared ray (IR) value around the electronic device;
determining, by the electronic device, whether a color temperature around the electronic device is changed, based on the illuminance value and the IR value around the electronic device;
in case of determining that the color temperature around the electronic device is changed, driving, by the electronic device, at least one of multiple camera circuits to obtain a color temperature value around the electronic device; and
changing, by the electronic device, a color temperature of a display, based on the color temperature value around the electronic device.

17. The method of claim 16, further comprising:
in case of determining whether the color temperature around the electronic device is changed,
identifying a first ratio between a first illuminance value and a first IR value around the electronic device, obtained at a first time point;
identifying a second ratio between a second illuminance value and a second IR value around the electronic device, obtained at a second time point after the first time point; and
determining whether the first ratio and the second ratio are different from each other.

18. The method of claim 17, further comprising, in case that the first ratio and the second ratio are different from each other, determining that the color temperature around the electronic device is changed.

19. The method of claim 17, further comprising, in case that the first ratio and the second ratio are not different from each other, determining that the color temperature around the electronic device is not changed.

20. The method of claim 16, further comprising:
matching the illuminance value and the IR value, and determining a type of light around the electronic device, based on an IR value matched to a specific illuminance value;
based on a size of the IR value relative to the illuminance value, classifying a light, of which the size of the IR value relative to the illuminance value is changed, as a first light group, and based on the first light group, driving at least one of the multiple camera circuits,
wherein, based on the classification of the first light group, at least one of the multiple camera circuits is driven at a time point when the color temperature around the electronic device is changed; and
based on the size of the IR value relative to the illuminance value, classifying a light, of which the size of the IR value relative to the illuminance value is not changed, as a second light group, and based on the classification of the second light group, driving at least one of the multiple camera circuits,
wherein, based on the second light group, at least one of the multiple camera circuits is driven at predetermined times or at predetermined periods.
